(19) United States
(12) Patent Application Publication
(10) Pub. No.: US 2026/0181379 A1
(43) Pub. Date: Jun. 25, 2026

(54) COOPERATIVE SERVICE CAPABILITY INFORMATION EXCHANGE

(71) Applicant: QUALCOMM Incorporated, San Diego, CA (US)

(72) Inventors: Hua WANG, Basking Ridge, NJ (US); Navid ABEDINI, Basking Ridge, NJ (US); Kapil GULATI, Belle Mead, NJ (US); Tien Viet NGUYEN, Bridgewater, NJ (US); Karl Georg HAMPEL, Jersey City, NJ (US); Tao LUO, San Diego, CA (US); Junyi LI, Greentown, PA (US)

(21) Appl. No.: 19/422,140

(22) Filed: Dec. 16, 2025

Related U.S. Application Data
(60) Provisional application No. 63/738,496, filed on Dec. 23, 2024.

(51) Int. Cl. H04W 8/22; H04W 76/15; H04W 92/18

(52) U.S. Cl. CPC H04W 8/22; H04W 76/15; H04W 92/18

(57) ABSTRACT

Methods, systems, and devices for wireless communications are described. A first wireless device may transmit a capability message indicative of one or more categories of one or more capabilities of the first wireless communications device to perform cooperative computing with one or more second wireless communications devices, the one or more categories of one or more sets of categories. The first wireless device may receive an indication that the first wireless communications device is to perform a cooperative computational task with the one or more second wireless communications devices, the cooperative computational task in accordance with the one or more categories of capabilities of the first wireless communications device. The first wireless device may transmit data, one or more inferences, or both to the one or more second wireless communications devices or to a network entity in accordance with the cooperative computational task and based on the indication.

### CROSS REFERENCES

The present Application for Patent claims benefit of U.S. Provisional Ser. No. 63/738,496 by WANG et al., entitled “COOPERATIVE SERVICE CAPABILITY INFORMATION EXCHANGE,” filed Dec. 23, 2024, assigned to the assignee hereof, and expressly incorporated herein.

### FIELD OF TECHNOLOGY

The following relates to wireless communications, including cooperative service capability information exchange.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Wireless communications devices may support cooperative services. For example, wireless communications devices may exchange data, inferences, or both to perform a cooperative service, such as alternatively to an individual device performing a service.

### SUMMARY

The systems, methods, and devices of this disclosure each have several innovative aspects, no single one of which is solely responsible for the desirable attributes disclosed herein.

A method for wireless communications by a first wireless communications device is described. The method may include transmitting a capability message indicative of one or more categories of one or more capabilities of the first wireless communications device to perform cooperative computing with one or more second wireless communications devices, the one or more categories of one or more sets of categories, receiving an indication that the first wireless communications device is to perform a cooperative computational task with the one or more second wireless communications devices, the cooperative computational task in accordance with the one or more categories of capabilities of the first wireless communications device, and transmitting data, one or more inferences, or both to the one or more second wireless communications devices or to a network entity in accordance with the cooperative computational task and based on the indication.

A first wireless communications device for wireless communications is described. The first wireless communications device may include one or more memories storing processor executable code, and one or more processors coupled with the one or more memories. The one or more processors may individually or collectively be operable to execute the code to cause the first wireless communications device to transmit a capability message indicative of one or more categories of one or more capabilities of the first wireless communications device to perform cooperative computing with one or more second wireless communications devices, the one or more categories of one or more sets of categories, receive an indication that the first wireless communications device is to perform a cooperative computational task with the one or more second wireless communications devices, the cooperative computational task in accordance with the one or more categories of capabilities of the first wireless communications device, and transmit data, one or more inferences, or both to the one or more second wireless communications devices or to a network entity in accordance with the cooperative computational task and based on the indication.

Another first wireless communications device for wireless communications is described. The first wireless communications device may include means for transmitting a capability message indicative of one or more categories of one or more capabilities of the first wireless communications device to perform cooperative computing with one or more second wireless communications devices, the one or more categories of one or more sets of categories, means for receiving an indication that the first wireless communications device is to perform a cooperative computational task with the one or more second wireless communications devices, the cooperative computational task in accordance with the one or more categories of capabilities of the first wireless communications device, and means for transmitting data, one or more inferences, or both to the one or more second wireless communications devices or to a network entity in accordance with the cooperative computational task and based on the indication.

A non-transitory computer-readable medium storing code for wireless communications is described. The code may include instructions executable by one or more processors to transmit a capability message indicative of one or more categories of one or more capabilities of the first wireless communications device to perform cooperative computing with one or more second wireless communications devices, the one or more categories of one or more sets of categories, receive an indication that the first wireless communications device is to perform a cooperative computational task with the one or more second wireless communications devices, the cooperative computational task in accordance with the one or more categories of capabilities of the first wireless communications device, and transmit data, one or more inferences, or both to the one or more second wireless communications devices or to a network entity in accordance with the cooperative computational task and based on the indication.

In some examples of the method, first wireless communications devices, and non-transitory computer-readable medium described herein, the one or more categories include respective ranges of capabilities, the one or more capabilities of the first wireless communications device being within the respective ranges.

In some examples of the method, first wireless communications devices, and non-transitory computer-readable medium described herein, the one or more categories correspond to respective computing capabilities of the first wireless communications device.

In some examples of the method, first wireless communications devices, and non-transitory computer-readable medium described herein, the respective computing capabilities include a floating-point operations per second (FLOPS) number capability, a memory capability, power level, or any combination thereof.

In some examples of the method, first wireless communications devices, and non-transitory computer-readable medium described herein, a first category of the one or more categories corresponds to multiple capabilities of the first wireless communications device.

In some examples of the method, first wireless communications devices, and non-transitory computer-readable medium described herein, the multiple capabilities include a FLOPs number capability and a memory capability.

In some examples of the method, first wireless communications devices, and non-transitory computer-readable medium described herein, a first category of the one or more categories includes a joint communication and computing capability of the first wireless communications device and a communication unit and a computing unit of the first wireless communications device share a common processing unit.

In some examples of the method, first wireless communications devices, and non-transitory computer-readable medium described herein, the one or more sets of categories may be included in one or more respective tables and the capability message may be indicative of the one or more categories in accordance with the capability message including one or more indexes of the one or more respective tables that correspond to the one or more categories.

Some examples of the method, first wireless communications devices, and non-transitory computer-readable medium described herein may further include operations, features, means, or instructions for receiving an indication of a minimum level, a maximum level, and a step size, where a first set of categories of the one or more sets of categories includes categories that may be in accordance with the minimum level, the maximum level, and the step size.

Some examples of the method, first wireless communications devices, and non-transitory computer-readable medium described herein may further include operations, features, means, or instructions for receiving an indication of the one or more capabilities to be reported by the first wireless communications device, where the capability message indicative of the one or more categories of the one or more capabilities of the first wireless communications device includes the one or more categories corresponding to the indication of the one or more capabilities to be reported.

In some examples of the method, first wireless communications devices, and non-transitory computer-readable medium described herein, the one or more capabilities to be reported may be indicated via an indication of the one or more sets of categories corresponding to the one or more capabilities.

In some examples of the method, first wireless communications devices, and non-transitory computer-readable medium described herein, the one or more capabilities may be based on a cooperative service provided by the first wireless communications device and the one or more second wireless communications devices.

Some examples of the method, first wireless communications devices, and non-transitory computer-readable medium described herein may further include operations, features, means, or instructions for receiving an indication of one or more quantities of bits to be used to indicate the one or more categories of the one or more capabilities of the first wireless communications device.

In some examples of the method, first wireless communications devices, and non-transitory computer-readable medium described herein, the one or more categories of the one or more capabilities may be indicative of a total quantity of computing resources in use by the first wireless communications device or a total quantity of available computing resources of the first wireless communications device.

In some examples of the method, first wireless communications devices, and non-transitory computer-readable medium described herein, the one or more capabilities of the first wireless communications device may be associated with a time range, a geographic area, or both.

In some examples of the method, first wireless communications devices, and non-transitory computer-readable medium described herein, the capability message includes an aggregated capability message indicative of the one or more categories of the one or more capabilities of the first wireless communications device and the one or more second wireless communications devices.

Some examples of the method, first wireless communications devices, and non-transitory computer-readable medium described herein may further include operations, features, means, or instructions for receiving an indication of respective one or more categories of capabilities of the one or more second wireless communications devices, where the capability message includes the aggregated capability message based on receiving the indication of the respective one or more categories of capabilities of the one or more second wireless communications devices, and where the first wireless communications device and the one or more second wireless communications devices include a cooperative device group.

In some examples of the method, first wireless communications devices, and non-transitory computer-readable medium described herein, receiving the indication that the first wireless communications device may be to perform the cooperative computational task may include operations, features, means, or instructions for receiving an indication of a cooperative service provided by a cooperative device group including the first wireless communications device and the one or more second wireless communications devices, the cooperative service including the cooperative computational task and one or more other cooperative computational tasks performed by the one or more second wireless communications devices.

Some examples of the method, first wireless communications devices, and non-transitory computer-readable medium described herein may further include operations, features, means, or instructions for transmitting, on behalf of a cooperative device group including the first wireless communications device and the one or more second wireless communications devices, an indication of a threshold quantity of devices capable of involvement in the cooperative computational task.

In some examples of the method, first wireless communications devices, and non-transitory computer-readable medium described herein, transmitting the capability message may include operations, features, means, or instructions for transmitting the capability message periodically or based on occurrence of a triggering event.

In some examples of the method, first wireless communications devices, and non-transitory computer-readable medium described herein, the capability message may be further indicative of a cooperative communication capability of the first wireless communications device.

In some examples of the method, first wireless communications devices, and non-transitory computer-readable medium described herein, the capability message may be indicative of a hardware capability of the first wireless communications device, a software capability of the first wireless communications device, or both.

In some examples of the method, first wireless communications devices, and non-transitory computer-readable medium described herein, the capability message may be indicative of communication or computation parameters or service metrics associated with the cooperative computing.

In some examples of the method, first wireless communications devices, and non-transitory computer-readable medium described herein, the capability message may be indicative of a power supply of the first wireless communications device, a power level of the first wireless communications device, or both.

A method for wireless communications by a network entity is described. The method may include obtaining a capability message indicative of one or more categories of one or more capabilities of a first wireless communications device to perform cooperative computing with one or more second wireless communications devices, the one or more categories of one or more sets of categories, outputting an indication that the first wireless communications device and the one or more second wireless communications devices are to perform a cooperative computational task, the cooperative computational task in accordance with the one or more categories of the one or more capabilities of the first wireless communications device, and obtaining data, one or more inferences, or both from the first wireless communications device or the one or more second wireless communications devices in accordance with the cooperative computational task and based on the indication.

A network entity for wireless communications is described. The network entity may include one or more memories storing processor executable code, and one or more processors coupled with the one or more memories. The one or more processors may individually or collectively be operable to execute the code to cause the network entity to obtain a capability message indicative of one or more categories of one or more capabilities of a first wireless communications device to perform cooperative computing with one or more second wireless communications devices, the one or more categories of one or more sets of categories, output an indication that the first wireless communications device and the one or more second wireless communications devices are to perform a cooperative computational task, the cooperative computational task in accordance with the one or more categories of the one or more capabilities of the first wireless communications device, and obtain data, one or more inferences, or both from the first wireless communications device or the one or more second wireless communications devices in accordance with the cooperative computational task and based on the indication.

Another network entity for wireless communications is described. The network entity may include means for obtaining a capability message indicative of one or more categories of one or more capabilities of a first wireless communications device to perform cooperative computing with one or more second wireless communications devices, the one or more categories of one or more sets of categories, means for outputting an indication that the first wireless communications device and the one or more second wireless communications devices are to perform a cooperative computational task, the cooperative computational task in accordance with the one or more categories of the one or more capabilities of the first wireless communications device, and means for obtaining data, one or more inferences, or both from the first wireless communications device or the one or more second wireless communications devices in accordance with the cooperative computational task and based on the indication.

A non-transitory computer-readable medium storing code for wireless communications is described. The code may include instructions executable by one or more processors to obtain a capability message indicative of one or more categories of one or more capabilities of a first wireless communications device to perform cooperative computing with one or more second wireless communications devices, the one or more categories of one or more sets of categories, output an indication that the first wireless communications device and the one or more second wireless communications devices are to perform a cooperative computational task, the cooperative computational task in accordance with the one or more categories of the one or more capabilities of the first wireless communications device, and obtain data, one or more inferences, or both from the first wireless communications device or the one or more second wireless communications devices in accordance with the cooperative computational task and based on the indication.

In some examples of the method, network entities, and non-transitory computer-readable medium described herein, the one or more categories include respective ranges of capabilities, the one or more capabilities of the first wireless communications device being within the respective ranges.

In some examples of the method, network entities, and non-transitory computer-readable medium described herein, the one or more categories correspond to respective computing capabilities of the first wireless communications device.

In some examples of the method, network entities, and non-transitory computer-readable medium described herein, the respective computing capabilities include a FLOPs number capability, a memory capability, power level, or any combination thereof.

In some examples of the method, network entities, and non-transitory computer-readable medium described herein, a first category of the one or more categories corresponds to multiple capabilities of the first wireless communications device.

In some examples of the method, network entities, and non-transitory computer-readable medium described herein, the multiple capabilities include a FLOPs number capability and a memory capability.

In some examples of the method, network entities, and non-transitory computer-readable medium described herein, a first category of the one or more categories includes a joint communication and computing capability of the first wireless communications device and a communication unit and a computing unit of the first wireless communications device share a common processing unit.

In some examples of the method, network entities, and non-transitory computer-readable medium described herein, the one or more sets of categories may be included in one or more respective tables and the capability message may be indicative of the one or more categories in accordance with the capability message including one or more indexes of the one or more respective tables that correspond to the one or more categories.

Some examples of the method, network entities, and non-transitory computer-readable medium described herein may further include operations, features, means, or instructions for outputting an indication of a minimum level, a maximum level, and a step size, where a first set of categories of the one or more sets of categories includes categories that may be in accordance with the minimum level, the maximum level, and the step size.

Some examples of the method, network entities, and non-transitory computer-readable medium described herein may further include operations, features, means, or instructions for outputting an indication of the one or more capabilities to be reported by the first wireless communications device, where the capability message indicative of the one or more categories of the one or more capabilities of the first wireless communications device includes the one or more categories corresponding to the indication of the one or more capabilities to be reported.

In some examples of the method, network entities, and non-transitory computer-readable medium described herein, the one or more capabilities to be reported may be indicated via an indication of the one or more sets of categories corresponding to the one or more capabilities.

In some examples of the method, network entities, and non-transitory computer-readable medium described herein, the one or more capabilities may be based on a cooperative service provided by the first wireless communications device and the one or more second wireless communications devices.

Some examples of the method, network entities, and non-transitory computer-readable medium described herein may further include operations, features, means, or instructions for outputting an indication of one or more quantities of bits to be used to indicate the one or more categories of the one or more capabilities of the first wireless communications device.

In some examples of the method, network entities, and non-transitory computer-readable medium described herein, the one or more categories of the one or more capabilities may be indicative of a total quantity of computing resources in use by the first wireless communications device or a total quantity of available computing resources of the first wireless communications device.

In some examples of the method, network entities, and non-transitory computer-readable medium described herein, the one or more capabilities of the first wireless communications device may be associated with a time range, a geographic area, or both.

In some examples of the method, network entities, and non-transitory computer-readable medium described herein, the capability message includes an aggregated capability message indicative of the one or more categories of the one or more capabilities of the first wireless communications device and the one or more second wireless communications devices.

In some examples of the method, network entities, and non-transitory computer-readable medium described herein, outputting the indication that the first wireless communications device and the one or more second wireless communications devices may be to perform the cooperative computational task may include operations, features, means, or instructions for outputting an indication of a cooperative service provided by a cooperative device group including the first wireless communications device and the one or more second wireless communications devices, the cooperative service including the cooperative computational task and one or more other cooperative computational tasks performed by the one or more second wireless communications devices.

Some examples of the method, network entities, and non-transitory computer-readable medium described herein may further include operations, features, means, or instructions for obtaining, via the first wireless communications device and on behalf of a cooperative device group including the first wireless communications device and the one or more second wireless communications devices, an indication of a threshold quantity of devices capable of involvement in the cooperative computational task.

In some examples of the method, network entities, and non-transitory computer-readable medium described herein, obtaining the capability message may include operations, features, means, or instructions for obtaining the capability message periodically or based on occurrence of a triggering event.

In some examples of the method, network entities, and non-transitory computer-readable medium described herein, the capability message may be further indicative of a cooperative communication capability of the first wireless communications device.

In some examples of the method, network entities, and non-transitory computer-readable medium described herein, the capability message may be indicative of a hardware capability of the first wireless communications device, a software capability of the first wireless communications device, or both.

In some examples of the method, network entities, and non-transitory computer-readable medium described herein, the capability message may be indicative of communication or computation parameters or service metrics associated with the cooperative computing.

In some examples of the method, network entities, and non-transitory computer-readable medium described herein, the capability message may be indicative of a power supply of the first wireless communications device, a power level of the first wireless communications device, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support cooperative service capability information exchange in accordance with one or more aspects of the present disclosure.

FIG. 3 shows an example of a process flow that supports cooperative service capability information exchange in accordance with one or more aspects of the present disclosure.

FIGS. 4 and 5 show diagrams of devices that support cooperative service capability information exchange in accordance with one or more aspects of the present disclosure.

FIG. 6 shows a diagram of a communications manager that supports cooperative service capability information exchange in accordance with one or more aspects of the present disclosure.

FIG. 7 shows a diagram of a system including a device that supports cooperative service capability information exchange in accordance with one or more aspects of the present disclosure.

FIGS. 8 and 9 show diagrams of devices that support cooperative service capability information exchange in accordance with one or more aspects of the present disclosure.

FIG. 10 shows a diagram of a communications manager that supports cooperative service capability information exchange in accordance with one or more aspects of the present disclosure.

FIG. 11 shows a diagram of a system including a device that supports cooperative service capability information exchange in accordance with one or more aspects of the present disclosure.

FIGS. 12 through 15 show flowcharts illustrating methods that support cooperative service capability information exchange in accordance with one or more aspects of the present disclosure.

### DETAILED DESCRIPTION

Wireless communications devices may perform cooperative services. For example, a first wireless communications device may cooperatively communicate with a network entity via a second wireless communications device, such as by forwarding messages received from a network entity to the second wireless communications device (e.g., downlink communications) or by receiving forwarded messages received from the second wireless communications device to the network entity (e.g., uplink communications). By forwarding the messages between the network entity and the second wireless communications device, the first device may extend the coverage of the network entity. Additionally, or alternatively, cooperative communications may improve energy saving at the first wireless communications device and the second wireless communications device. In some cases, wireless communications devices may perform cooperative computing. For example, the first wireless communications device and the second wireless communications device may jointly perform a computing task. That is, the first wireless communications device may use one or more computing resources of the second wireless communications device for a computation intensive or memory intensive application. By sharing the computing load, the first wireless communications device and the second wireless communications device may perform a computation task that, in some cases, the first wireless communications device may be incapable of performing alone. In some cases, performance levels of cooperative services, such as a quality of service (QoS) of a cooperative service, may be based on respective capabilities of the wireless communications devices or a collective capability of the wireless communications devices to perform the cooperative services. For example, the wireless communications devices share computational loads and exchange data to support the cooperative services, and the computational loads and abilities to exchange data at each wireless communications devices may be based on their respective capabilities. As such, wireless communications systems described herein may implement capability information exchanges in association with performance of cooperative services.

Techniques described herein relate to exchanges of capability information related to cooperative services. For example, wireless communications devices described herein may report capabilities associated with performance of cooperative services, including cooperative communications and cooperative computation. The wireless communications devices may report the capabilities as being in a category. For example, a category as used herein may refer to a range of capability of multiple ranges for a given capability. Additionally, or alternatively, a category may refer to combinations of different capabilities. That is, rather than indicating a capability as an exact number, a wireless communications device may reduce a quantity of bits required to indicate the capability by indicating the capability as a category. In some examples, the categories may be configured by a network entity, such as via indication of a minimum level, a maximum level, and a step size. Alternatively, the categories may be predefined or stored in memories of the wireless communications devices, such as in a table where various indexes of the table correspond to different categories. The wireless communications devices may receive indications of cooperative services to be performed in accordance with the reported capabilities. For example, a wireless communications device may receive an indication of operations to be performed in association with a cooperative service, where one or more other operations are performed by other wireless communications devices. In other words, the wireless communications devices may receive an indication of how operations of a cooperative service are allocated or split between the various devices involved in the cooperative service. Based on the indication, the wireless communications devices output data or inferences to other wireless communications devices.

Aspects of the disclosure are initially described in the context of wireless communications systems. Aspects of the disclosure are also described in the context of a process flow. Aspects of the disclosure are further illustrated by and described with reference to apparatus diagrams, system diagrams, and flowcharts that relate to cooperative service capability information exchange.

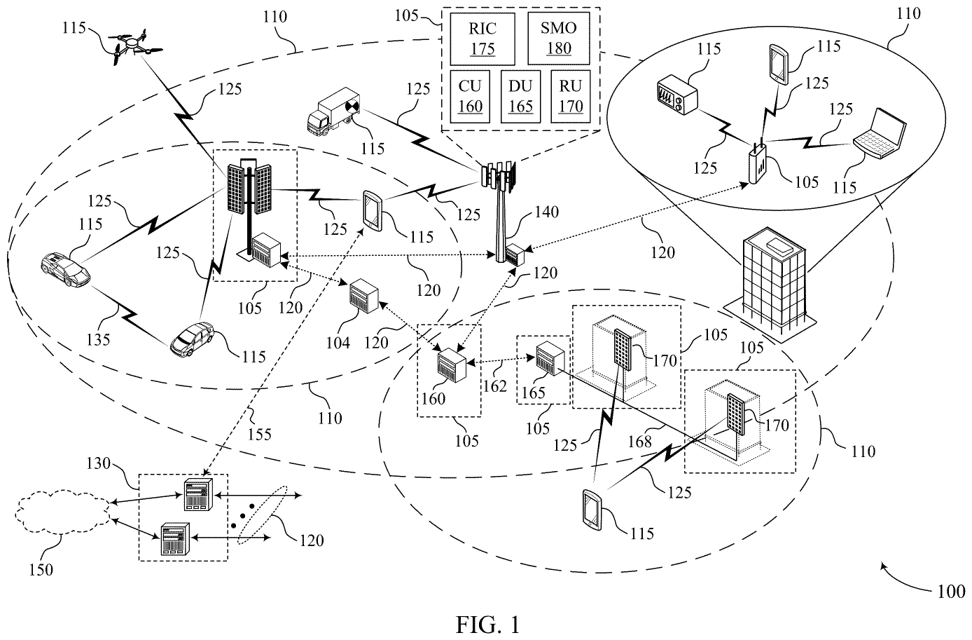

FIG. 1 shows an example of a wireless communications system 100 that supports cooperative service capability information exchange in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L 3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L 1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support cooperative service capability information exchange as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δθₘₐₓ·N_{θ}) seconds, for which Δθₘₐₓ may represent a supported subcarrier spacing, and N_{θ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{θ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the network entity 105, the UE 115, and one or more other UEs 115 may perform cooperative services, such as cooperative communications or cooperative computation. Cooperative communications (e.g., joint communication) may involve forwarding of communications, such as communications from a network entity 105, between UEs. For example, a UE 115 may be an example of a cooperative UE that forwards communications from the network entity 105 to a target UE via a sidelink communications link or another type of communications link. Cooperative communications may support improved coverage. For example, the target UE may communicate with the network entity 105 via the UE 115 (e.g., the cooperative UE) for downlink communications, uplink communications, or both. Additionally, or alternatively, cooperative communications may support energy saving. For example, target UE may communicate with the network entity 105 via the UE 115 (e.g., the cooperative UE) having improved energy saving capabilities. That is, the cooperative UE may have a capability to communicate with the network entity 105 via fewer energy resources compared to the target UE. Cooperative communications may be a generalized multiple transmission-reception point (M-TRP) operation in which a cooperative UE is equivalent to a transmission port. For example, when performing cooperative communications, the UE 115 may be equivalent to a transmission point in which multiple TRPs serve the target UE and one or more other UEs.

In addition to or alternatively from cooperative communications, wireless communications devices may perform cooperative computation. For example, devices may cooperate for distributed computing via wireless communication links. Cooperative computation may involve use of a computing resource of another device by a wireless communications device. That is, a first wireless communications device may use a computing resource of a second wireless communications device for a computation intensive or a memory intensive application. The other device may be another UE or, in some other examples, may be an application server (e.g., split computing for XR).

Cooperative devices may form a group (e.g., a cooperative device group) and jointly provide communication or computing services (e.g., cooperative services) to other devices, which may be referred to as or be examples of client devices. Additionally, or alternatively, client devices may also be a part of the cooperative device group. Cooperative services may support multiple applications. For example, cooperative services may involve one or more large language models (LLMs) that generate inferences running on a device. That is, a first device may use a computing or memory resources from one or more other devices to run a larger LLM model for inference (e.g., relative to an LLM model that the first device is capable of running alone). Additionally, or alternatively, cooperative services may involve on-device artificial intelligence (AI) or machine learning (ML) training for communications on a network services platform (NSP). The NSP may be utilized for online device learning. For example, online device learning may be an example of training that utilizes NSP for continuous training and model updates (e.g., ongoing prototyping). In another example, cooperative services may involve channel state feedback (CSF) computation distribution. As an example, CSF computation for a smart watch may be offloaded to a phone. In such examples, by implementing a relatively relaxed timeline for the smart watch and by using CSF distribution, the smart watch may provide CSF.

For devices to cooperatively provide a service, the devices may share the computational load and transfer data among themselves for processing. That is, cooperative devices may provide a cooperative service by sharing the computational load and by exchanging data and inferences for processing. Cooperative services may involve (e.g., require) data transfer(s) between devices of the cooperative device group, the network (e.g., the network entity 105, or another network device), and a client device. Accordingly, a QoS of the cooperative services may be based on the computational and communication capabilities and availabilities of the cooperative devices.

Cooperative devices may be in a vicinity of each other and, in some cases, may communicate via Wi-Fi or sidelink communications links (e.g., 5G or sixth generation (6G) sidelink communications links) to fulfill cooperative services. As an example, cooperative devices may be in a local mesh network. In such examples, to efficiently share a service load, cooperative devices may exchange information about their communication and computing capabilities and availability. Additionally, or alternatively, cooperative devices may be in different locations and may be connected via a core network and/or the Internet. As an example, cooperative devices may be in a mobile edge network. In such examples, cooperative devices may exchange information about their communication and computing capabilities and availability with the network to ensure efficient and effective service delivery.

Techniques described herein support exchanges of capability information about cooperative services (e.g., cooperative communication and/or computing) by wireless communications devices with the network and with other wireless communications devices (e.g., in a cooperative device group). For example, devices may exchange types of information in accordance with being a cooperative device (e.g., a cooperative UE, as an example), methods to organize the information, and signals by which the information may be communicated.

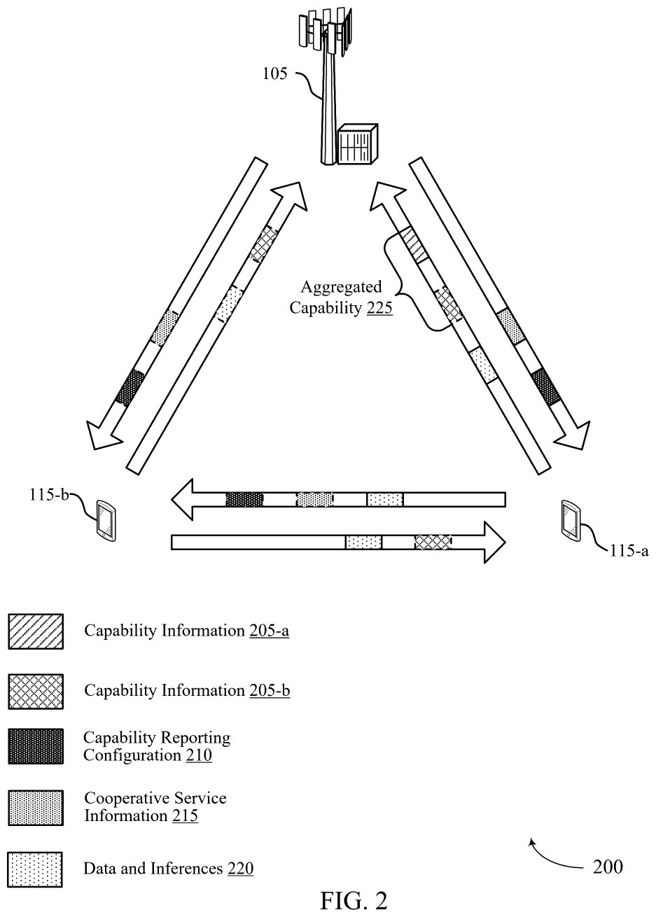

FIG. 2 shows an example of a wireless communications system 200 that supports cooperative service capability information exchange in accordance with one or more aspects of the present disclosure. The wireless communications system 200 may implement or be implemented by the wireless communications system 100. For example, the wireless communications system 200 may include a network entity 105, a UE 115-a, and a UE 115-b, which may be examples of corresponding devices as described with reference to FIG. 1.

The devices in the wireless communications system 200 may support a cooperative service based on an exchange of capability information. For example, the UE 115-a and the UE 115-b may be examples of devices in a cooperative device group. In some examples, the UE 115-a may be a group leader UE of the cooperative device group. For example, the UE 115-a may, for some signals, communicate with the network entity 105 on behalf of the cooperative device group including the UE 115-b. While the cooperative device group is depicted as including the UE 115-a and the UE 115-b, it may be understood that devices other than UEs may be included in the cooperative device group. As an example, the cooperative device group may include multiple TRPs. For example, a RAN, network entity, or TRP may also provide a computing service. Accordingly, the UE 115-a and the UE 115-b described as performing the cooperative service may, in some examples, be a network node. A RAN, network entity, or TRP may also provide a distributed computing service to be matched up with one or more UEs and exchange information with those UEs. That is, a cooperative device group that performs a cooperative service described herein (e.g., and reports capability information in accordance with such a service) may include multiple types of devices and different combinations of the multiple types of devices. Additionally, or alternatively, while the cooperative device group is depicted as being in communication with the network entity 105, it may be understood that a device other than a network entity may communicate with the cooperative device group, and some communications described herein may be within the cooperative device group (e.g., without a network entity).

The UE 115-a may transmit capability information 205-a to the network entity 105. The capability information may be in association with (e.g., support, be related to, etc.) a cooperative service performed by the cooperative device group including the UE 115-a. For example, the capability information 205-a may include information about communication or computing. As an example, information about communication may include throughput, delay, or both for links between devices. That is, the capability information 205-a may include a throughput, a delay, or both of a communications link between the UE 115-a and the UE 115-b. Information about computing may include a floating point operations per second (FLOPS) number, memory, or both. That is, the capability information 205-a may include information related to processing and memory capabilities of the UE 115-a.

In some examples, the capability information 205-a may include information about hardware or software. Information about hardware may include a type and quantity of central processing unit (CPU) cores, graphics processing units (GPUs), or both of the UE 115-a. Information about software may include a name and version of an ML model stored on the UE 115-a. Additionally, or alternatively, the capability information 205-a may include information about low-level communication or computation parameters or high-level information about service metrics, or any combination thereof. For example, for an LLM inference service, the information may include a batch size, tokens per second, a context length, or the like. Alternatively, or additionally, for an XR rendering service, the information may include frames per second, a rendering delay, or the like. The capability information 205-a may include a power supply, a power level, or both of the UE 115-a. As an example, the capability information may indicate whether the UE 115-a has a plugged-in power supply, which may be used to perform tasks that involve a sustained (e.g., relatively long) processing time compared to other tasks. For example, a battery-powered device may be less suitable for the tasks involving the sustained processing time based on having a limited power availability.

The UE 115-a may transmit per-device information or aggregated device group information. For example, the UE 115-a may transmit capability information 205-b of the UE 115-b on behalf of the UE 115-b (e.g., as a group leader UE). In some examples, the UE 115-a may transmit the capability information 205-a (e.g., its own capability information) and the capability information 205-b (e.g., of another device) independently or separately, such as in the form of per-device information. Alternatively, the UE 115-a may aggregate the capability information into an aggregated capability 225. The aggregated capability 225 may identify the capabilities as being of the cooperative device group as a whole rather than capabilities of individual devices of the cooperative device group.

A type of information that the capability information 205-a includes may refer to a “classification” of the information. That is, the capability information 205-a may be classified as the information about communication or computing, hardware or software, low-level communication or computation parameters or high-level information about service metrics, per-device or aggregated device group information, power supply and power level, or the like.

The UE 115-a may report the capability information as a device computing category for a computing capability. For example, rather than indicating a computing capability as an exact number (e.g., a TOPS number, a number of gigabytes, etc.), the UE 115-a may report the computing capability as one of multiple categories defined for the computing capability. Because different types of devices have capabilities that span a large range, indicating a capability as an exact number may require a large quantity of bits. For example, some devices may be capable of 34 TOPS, while others may be capable of 1,300 TOPS. In order to have the capability to indicate a capability of 1,300 TOPS, an allocation of at least 4 bits may be necessary (e.g., despite some devices only needing 2 bits to indicate the capability). In other words, enough bits need to be allocated for exchanging an exact number of TOPS, a memory, etc. to accommodate a vast range of capabilities. Accordingly, indicating the exact number may involve a relatively large payload, quantity of resources, and power compared to indicating a category of capability via fewer bits. To reduce overhead, different categories may be defined for computing capability.

For example, individual categories may be defined for each computing capability. As an example, for a FLOPS number, categories may include tera operations per second (TOPS) in ranges [0, 16), [17, 32), [32, 128), etc. Alternatively, for memory, there may be categories in gigabyte ranges [0, 4), [4, 8), [8, 16), etc. For power level, there may be categories with various power level ranges, such as [10%, 20%), [20%, 30%), etc. Alternatively, or additionally, there may be first category of battery power and a second category for plug-in power. The capability information 205-a may include an indication of one or more categories of capabilities for the UE 115-a. For example, the capability information 205-a may include an indication that the UE 115-a has a FLOPS number in the range [17, 32) and a power level in a range [90%, 100%). That is, the capability information 205-a may include an indication of a category of FLOPS number capability and, separately, a category of power level capability for the UE 115-a.

In some examples, categories may encompass several metrics of computing capability for a device. For example, categories may be defined that combine two or more capabilities. As an example, a FLOPS number and memory capability may be combined and jointed defined, as well as indicated, via a single category. Categories of capabilities for the FLOPS number and the memory capability may include various combinations of FLOPS number and memory capability ranges, such as a first category including a TOPS number range of [32, 128) and a memory range of [8, 16) gigabytes. In such examples, the capability information 205-a may include an indication of this first category to jointly indicate, via a single category, both the FLOPS number capability and the memory capability.

In examples in which a communication element and a computing element of a device share some common processing unit, one or more categories for joint communication and computing may be defined. As an example, the communication and the computing elements may share a common processing unit in neural network signal processing examples. That is, the communication and computing elements may use a same neural network. As an example, semantic communication and XR rendering may share a same transformer block on a chip. In such cases, communication and computing performance may not be independent and, thus, may be conveyed as a combined capability. In other words, the capability information 205-a may include a category indicative of a joint communication and computing capability of the UE 115-a based on the UE 115-a having a common processing unit for communication and computing.

Categories for different capabilities may be pre-defined in a table. For example, the table may include, along a first dimension, different capabilities and, along a second dimension, categories corresponding to each capability. That is, a column of the table may correspond to a FLOPS number capability, where different entries in the column (e.g., in different rows) include ranges of FLOPS numbers corresponding to different categories. In such examples, the capability information 205-a may be indicative of a category of a capability by indicating an index (e.g., pointing to a row) of the table. A memory of the UE 115-a, the UE 115-b, and the network entity 105 may store the table in which the capabilities are pre-defined. For example, categories may be defined using a minimum level (e.g., min-level), a maximum level (e.g., max-level), and a step size. As an example, a power level may be defined as having a minimum level of 10% (e.g., min=10%), a maximum level of 100% (e.g., max=100%), and a step size of 10%. Different minimum levels, maximum levels, and step sizes may be defined for different capabilities, such as based on a range that a capability may be (e.g., how variable a capability may be over different devices).

Alternatively, or additionally, categories for different capabilities may be configured by the network entity 105. In such examples, the network entity 105 may indicate the minimum level, the maximum level, and the step size. For example, the network entity 105 may transmit a capability reporting configuration 210 to the UE 115-a and the UE 115-b (e.g., directly or indirectly, such as via the UE 115-a). The capability reporting configuration 210 may include an indication of one or more combinations of one or more minimum levels, one or more maximum levels, and one or more step sizes that define categories for one or more capabilities. In some examples, the step size may be unspecified, and the network entity 105 may indicate a quantity of bits to be used in capability reporting. In such examples, based on the quantity of bits, the range between the minimum level and the maximum level may be linearly divided into categories of a capability according to 2\hat{ }(quantity of bits).

In some examples, the network entity 105 may indicate which capabilities to be reported. For example, the network entity 105 may transmit, to the UE 115-a and the UE 115-b (e.g., directly or indirectly), the capability reporting configuration 210 including an indication of capabilities to be reported. That is, the network entity 105 may request that the UE 115-a and the UE 115-b report one or more capabilities, such as report a FLOPS number and a memory capability. Additionally, or alternatively, the network entity 105 may indicate whether the capabilities are to be reported to the network entity 105 or exchanged between the devices in the cooperative device group. That is, the network entity 105 may indicate that the UE 115-a and the UE 115-b are to exchange capability information including one or more indicated capabilities. Additionally, the capability reporting configuration 210 may include an indication of categories for each capability that the cooperative devices should use in the reporting.

In some examples, the capability to be reported and the category to use may be based on a cooperative service provided by the cooperative devices. As an example, the network entity 105 may configure the cooperative devices to report an aggregated capability 225 of a quantity of CPUs and GPUs and the one or more ML modes the cooperative devices are capable of using. The network entity 105 may determine which ML service may be deployed to the cooperative devices based on the information. Additionally, or alternatively, the network entity 105 may configure devices in the cooperative group to report a FLOPS number and memory such that the network entity 105 may determine to which device a computational task may be offloaded. That is, the network entity 105 may request the capability information based on a cooperative service to be allocated to the cooperative devices and information that is relevant to that cooperative service and, after obtaining the capability information, may deploy (e.g., assign, allocate) that cooperative service to the cooperative devices in accordance with the capability information.

In some examples, the network entity 105 may indicate a quantity of bits to be used for reporting one or more categories. That is, the capability reporting configuration 210 may include an indication of, for each capability, how many bits to use to indicate a category for the capability. As an example, the network entity 105 may configure 3 bits to report a category of FLOPS number. In examples in which the FLOPS number is defined according to 16 categories (e.g., 16 entries in a table), the UE 115-a and the UE 115-b may report a most-significant 3 bits. By indicating the most-significant 3 bits, the UE 115-a and the UE 115-b may effectively be using a coarser definition of the categories for the FLOPS number (e.g., 8 entries for a table rather than 16).

The capability information 205-a may include information related to resources in-use or available resources for the UE 115-a. For example, a category for a computing capability may refer to a total amount of computing resources of the UE 115-a, such as a total FLOPS number and a total memory size. Alternatively, or additionally, the category may refer to available computing resources, such as memory and computational headroom. That is, the category may indicate how much memory or FLOPS the UE 115-a has available to be allocated to a cooperative service.

In some examples, the UE 115-a may pre-register a category for a capability. That is, a device may pre-register one or more default capability categories in association with a time range, location, or both. As an example, the capability information 205-a may be an example of a pre-registration of a capability of the UE 115-a for cooperative services at an identified time range, geographic area, or both. In such examples, the network entity 105 may store and retrieve the pre-registered capability of the UE 115-a when allocating a UE 115-a in accordance with a cooperative service. That is, the network entity 105 may determine, based on a time and location of the UE 115-a, which category capability of the UE 115-a is registered as (e.g., belongs to). As an example, the UE 115-a may be busy during working hours (e.g., between 9 AM and 5 PM at a local time of the device) and, in such a time range, may register with a category associated with a relatively low FLOPS number. Alternatively, or additionally, during sleeping hours (e.g., between 10 PM and 7 AM at a local time of the device), the UE 115-a may register with a category associated with a relatively high FLOPS number. In another example, while traveling (e.g., away from a home location of the device), the UE 115-a may register with a category of a power capability of battery powered. Alternatively, or additionally, while at home, the UE 115-a may register with a category of the power capability of plugged in. By pre-registering the categories for different times and locations, the UE 115-a may reduce an amount of reporting to the network entity.

The capability information 205-a may include information about software. As an example, the capability information 205-a may indicate that the UE 115-a has loaded a Llama 2 model in memory, or that the UE 115-a has Llama 3 model on a hard drive but not loaded in memory. Additionally, or alternatively, the capability information 205-a may indicate a capability for a service provided by the UE 115-a. As an example, if the UE 115-a provides an LLM inference service, the UE 115-a may report a capability in terms of batch size, tokens per second, context length, etc. In another example, if the UE 115-a provides XR rendering, the UE 115-a may report a capability in terms of frame per second, rendering delay, etc. The software information, the service information, or both may be reported as a category for the capabilities.

In some examples, a cooperative device group may report an aggregated capability. For example, the cooperative device group including the UE 115-a and the UE 115-b may report an aggregated capability 225 to the network entity 105, such as rather than reporting individual capability information of each device. In the example of FIG. 2, the UE 115-a may report the aggregated capability 225 on behalf of the cooperative device group. In some examples, the aggregated capability 225 may include low-level computing capabilities, such as total TOPS, memory, or both across the devices in the cooperative device group and communication capabilities such as throughput and delay. In such examples, the delay may be an accumulated end-to-end delay for a service, and, in some examples, the delay may be separately indicated as a device-to-network delay (e.g., a delay between the UE 115-a or the UE 115-b and the network entity 105) and an inter-device delay (e.g., a delay between the UE 115-a and the UE 115-b). Alternatively, or additionally, the aggregated capability 225 may include high-level performance metric(s) related to one or more services that the cooperative device group provides.

In examples in which the cooperative device group reports the aggregated capability 225 including low-level communication, computing, and software capabilities to the network entity 105, the network entity 105 may determine which service the cooperative device group is to provide. That is, based on the aggregated capability 225, the network entity 105 may determine a cooperative service to be provided by the cooperative device group. The network entity 105 may instruct the cooperative device group to prepare initialization steps to provide the service. For example, the network entity 105 may transmit cooperative service information 215 to the devices of the cooperative device group, where the cooperative service information 215 includes an indication of the service to be provided by the cooperative device group in accordance with the aggregated capability 225. As an example, the aggregated capability 225 may indicate a capability of the cooperative device group to run multiple LLM models. The cooperative device group may not determine, prior to reporting the aggregated capability 225, which model to load. The network entity 105, in such examples, may instruct the cooperative device group to load or switch to an identified model in accordance with client requests.

The aggregated capability 225 may include an indication of a threshold quantity of devices with which the cooperative device group is capable of performing distributed computing with. For example, the cooperative device group may indicate how many other devices may be added to the group for performance of distributed computing. Based on the aggregated capability, the network entity 105 may instruct a set of devices to form a cooperative group. That is, the network entity 105 may add devices to the cooperative device group, remove devices from the cooperative device group, or form a different cooperative device group. In some examples, the network entity 105 may include a network entity or a TRP in a cooperative group in examples in which the network entity or the TRP has distributed computing capabilities.

Aggregated capability reporting may be used in examples in which UEs are within a vicinity of each other (e.g., within a threshold range). Alternatively, individual reporting of low-level capabilities where a network entity may determine the cooperative device group and which service the group may provide jointly may be used in examples in which UEs are relatively more remote from each other.

In some examples, a cooperative device group may advertise multiple or a range of different capabilities or categories, where each capability or category is associated with a different cost. For example, a cooperative device group may advertise that it is capable of supporting a set of capabilities (e.g., defined according to a category for those capabilities, or exact numbers) at a monetary cost, an amount of energy consumption, a QoS, or the like. That is, each set of capabilities (e.g., or ranges thereof) may be advertised as being associated with different logical values that are based on an amount of energy consumption, a cost of service, a QoS, or the like.

The UE 115-a may indicate the capability information 205-a via one or more signaling methods. For example, the UE 115-a may indicate the capability information 205 via user assisted information, UE capability reporting, application layer messaging, or the like.

In some examples, the UE 115-a may report the capability information 205-a on a periodic or an event-driven basis. For example, cooperative device groups and capabilities of devices within cooperative device groups may change based on devices leaving and joining the cooperative device group; a device running a local task consuming memory, power and FLOPS, etc.; or the like. In such examples, the cooperative devices may exchange capability information such that changes to the group or capabilities of devices within the group are updated. For example, the cooperative device group may exchange the capability information periodically. Additionally, or alternatively, the cooperative device group may exchange the capability information based on an event trigger, such as a capability category of the devices, the cooperative device group, or both changing. In some examples, devices may predict a capability change and preemptively report the capability change. As an example, the UE 115-a may predict a change to a memory or computational headroom of the UE 115-a and send capability information 205-a including a predicted update to the network entity 105.

The UE 115-a, the UE 115-b, the network entity 105 (e.g., RAN, TRP, gNB, etc.), or any combination thereof may exchange data and inferences 220 in accordance with the cooperative service. For example, after exchanging capability information and, in accordance with the capability information, exchanging cooperative service information 215, the devices may perform, collectively, a cooperative service. The cooperative service may involve performance of individual operations at the respective devices and, based on those individual operations, the devices may exchange data and inferences 220. The data exchanged may refer to a computation cooperatively performed by the UE 115-a, the UE 115-b, the network entity 105, or any combination thereof, as part of a cooperative computational task. Similarly, an inference exchanged may refer to an output of an LLM, ML, neural network, or the like, operating on the UE 115-a, the UE 115-b, the network entity 105, or any combination thereof, as part of a cooperative computational task.

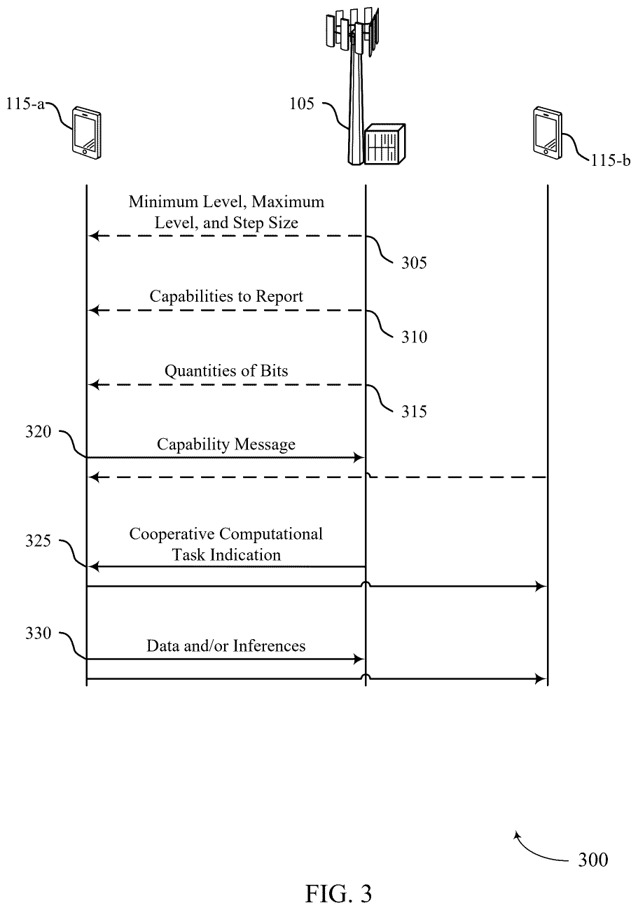

FIG. 3 shows an example of a process flow 300 that supports cooperative service capability information exchange in accordance with one or more aspects of the present disclosure. The process flow 300 may implement or be implemented by aspects of the wireless communications system 100, the wireless communications system 200, or both. For example, the process flow 300 may include a network entity 105, a UE 115-a, and a UE 115-b, which may be examples of corresponding devices as described with reference to FIGS. 1 and 2.

Alternative examples of the following may be implemented, where some operations are performed in a different order than described or are not performed at all. In some examples, operations may include additional features not mentioned below, or further operations may be added. Although the network entity 105, the UE 115-a, and the UE 115-b are shown performing the operations of the process flow 300, some aspects of some operations may also be performed by one or more other wireless devices.

In some examples, the network entity 105 may provide, prior to receipt of capability information, information regarding capability reporting to devices that are to report capabilities to the network entity 105. For example, the network entity 105 may indicate capability reporting information, such as the capability reporting information provided in the capability reporting configuration 210 as described with reference to FIG. 2. The capability information may include information related to defining different categories for different capabilities to be reported, indicating which capabilities are to be reported, how capabilities are to be reported, or the like.

For example, at 305, the network entity 105 may indicate a minimum level, a maximum level, and a step size. That is, the UE 115-a may receive an indication of a minimum level, a maximum level, and a step size, where a first set of categories of one or more sets of categories may include categories that are in accordance with the minimum level, the maximum level, and the step size. In other words, the minimum level, the maximum level, and the step size may define different categories for a capability.

At 310, the network entity 105 may indicate capabilities to report. For example, the UE 115-a may receive an indication of one or more capabilities to be reported by the UE 115-a. In such examples, the capability message may include the one or more categories corresponding to the indication of the one or more capabilities to be reported. In some examples, the one or more capabilities to be reported may be indicated via an indication of the one or more sets of categories corresponding to the one or more capabilities. That is, the network entity 105 may define categories for the capabilities to be reported in the indication. The one or more capabilities may be indicated by the network entity 105 based on a cooperative service provided by the UE 115-a and the one or more second wireless communications devices.

At 315, the network entity 105 may indicate quantities of bits. For example, the UE 115-a may receive an indication of one or more quantities of bits to be used to indicate the one or more categories of the one or more capabilities of the UE 115-a. That is, the network entity 105 may indicate how many bits the UE 115-a may use to report categories for requested capabilities.

At 320, the UE 115-a may transmit a capability message. For example, the UE 115-a may transmit a capability message indicative of one or more categories of one or more capabilities of the UE 115-a to perform cooperative computing with one or more second wireless communications devices, the one or more categories of one or more sets of categories. The capability message may be an example of the capability information 205-a transmitted by the UE 115-a in the example of FIG. 2. In some examples, the one or more categories may include respective ranges of capabilities, the one or more capabilities of the UE 115-a being within the respective ranges. The UE 115-a may transmit the capability message periodically or based on occurrence of a triggering event. In some examples, the capability message may be further indicative of a cooperative communication capability, a hardware capability, a software capability, or any combination thereof of the UE 115-a. Additionally, or alternatively, the capability message may be indicative of communication or computation parameters or service metrics associated with cooperative computing, a power supply of the UE 115-a, a power level of the UE 115-a, or any combination thereof.

The one or more categories may correspond to respective computing capabilities of the UE 115-a. For example, the respective computing capabilities may include a FLOPS number capability, a memory capability, power level, or any combination thereof. In some examples, a first category of the one or more categories may correspond to multiple capabilities of the UE 115-a. For example, the multiple capabilities may include a FLOPS number capability and a memory capability of the UE 115-a.

In some examples, a first category of the one or more categories may include a joint communication and computing capability of the UE 115-a. In such examples, a communication unit and a computing unit of the UE 115-a may share a common processing unit. The one or more sets of categories may be included in one or more respective tables. In such examples, the capability message may be indicative of the one or more categories in accordance with the capability message including one or more indexes of the one or more respective tables that correspond to the one or more categories.

The capability message may be indicative of in-use or available resources. For example, the one or more categories of the one or more capabilities may be indicative of a total quantity of computing resources in use by the UE 115-a or a total quantity of available computing resources of the UE 115-a. Additionally, or alternatively, the capability message may be indicative of a registration or pre-registration of capabilities of the UE 115-a at a time range, a geographic location, or both. That is, the one or more capabilities of the UE 115-a may be associated with a time range, a geographic area, or both.

In some examples, the capability message may be an aggregated capability message indicative of the one or more categories of the one or more capabilities of the UE 115-a and the one or more second wireless communications devices (e.g., including the UE 115-b). For example, the capability message may indicate an aggregated capability of a cooperative device group, such as the aggregated capability 225 as described with reference to FIG. 2. In such examples, the UE 115-a may receive an indication of respective one or more categories of capabilities of the UE 115-b, where the capability message includes the aggregated capability message based on receiving the indication of the respective one or more categories of capabilities of the UE 115-b, and where the UE 115-a and the UE 115-b are in a cooperative device group. Additionally, or alternatively, the UE 115-a may transmit, on behalf of the cooperative device group, an indication of a threshold quantity of devices capable of involvement in a cooperative computational task.

At 325, the network entity 105 may transmit an indication of a cooperative computational task. The indication of the cooperative computational task may be an example of the cooperative service information 215 as described with reference to FIG. 2. For example, the UE 115-a may receive an indication that the UE 115-a is to perform a cooperative computational task with the one or more second wireless communications devices, the cooperative computational task in accordance with the one or more categories of capabilities of the UE 115-a. In some examples, the UE 115-a may receive an indication of a cooperative service provided by a cooperative device group including the UE 115-a and the UE 115-b, the cooperative service including the cooperative computational task and one or more other cooperative computational tasks performed by the UE 115-b.

At 330, the UE 115-a may transmit data and/or inferences to the network entity 105, to the UE 115-b, or both. For example, the UE 115-a may transmit data, one or more inferences, or both to the one or more second wireless communications devices (e.g., including the UE 115-b) or to the network entity 105 in accordance with the cooperative computational task and based on the indication. The data and/or inferences may be an example of the data and inferences 220 as described with reference to FIG. 2.

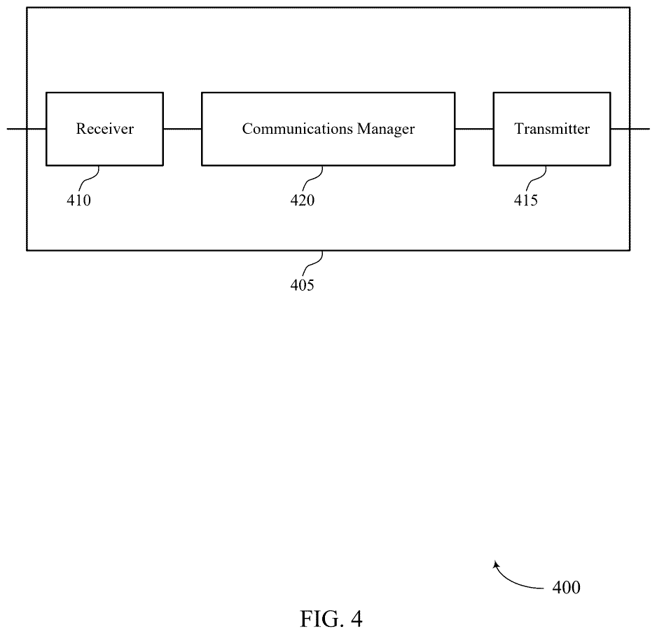

FIG. 4 shows a diagram 400 of a device 405 that supports cooperative service capability information exchange in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to cooperative service capability information exchange). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to cooperative service capability information exchange). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of cooperative service capability information exchange as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for transmitting a capability message indicative of one or more categories of one or more capabilities of the first wireless communications device to perform cooperative computing with one or more second wireless communications devices, the one or more categories of one or more sets of categories. The communications manager 420 is capable of, configured to, or operable to support a means for receiving an indication that the first wireless communications device is to perform a cooperative computational task with the one or more second wireless communications devices, the cooperative computational task in accordance with the one or more categories of capabilities of the first wireless communications device. The communications manager 420 is capable of, configured to, or operable to support a means for transmitting data, one or more inferences, or both to the one or more second wireless communications devices or to a network entity in accordance with the cooperative computational task and based on the indication.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, and more efficient utilization of communication resources.

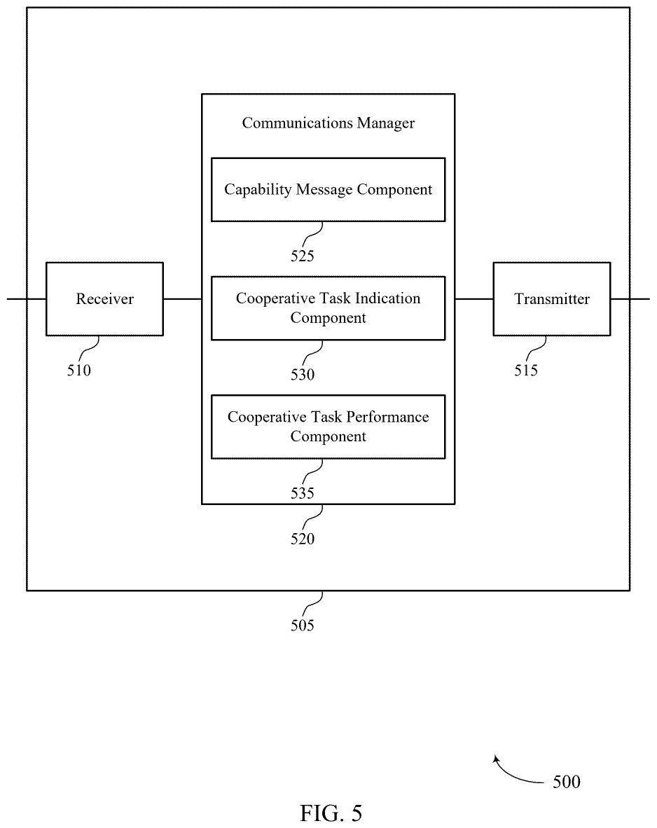

FIG. 5 shows a diagram 500 of a device 505 that supports cooperative service capability information exchange in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to cooperative service capability information exchange). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to cooperative service capability information exchange). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of cooperative service capability information exchange as described herein. For example, the communications manager 520 may include a capability message component 525, a cooperative task indication component 530, a cooperative task performance component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The capability message component 525 is capable of, configured to, or operable to support a means for transmitting a capability message indicative of one or more categories of one or more capabilities of the first wireless communications device to perform cooperative computing with one or more second wireless communications devices, the one or more categories of one or more sets of categories. The cooperative task indication component 530 is capable of, configured to, or operable to support a means for receiving an indication that the first wireless communications device is to perform a cooperative computational task with the one or more second wireless communications devices, the cooperative computational task in accordance with the one or more categories of capabilities of the first wireless communications device. The cooperative task performance component 535 is capable of, configured to, or operable to support a means for transmitting data, one or more inferences, or both to the one or more second wireless communications devices or to a network entity in accordance with the cooperative computational task and based on the indication.

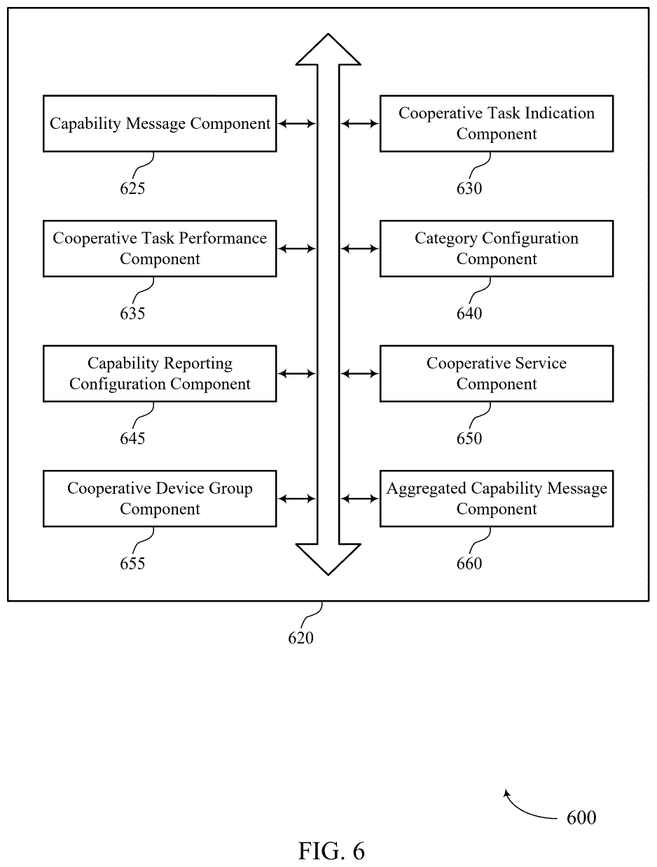

FIG. 6 shows a diagram 600 of a communications manager 620 that supports cooperative service capability information exchange in accordance with one or more aspects of the present disclosure. The communications manager 620 may be an example of aspects of a communications manager 420, a communications manager 520, or both, as described herein. The communications manager 620, or various components thereof, may be an example of means for performing various aspects of cooperative service capability information exchange as described herein. For example, the communications manager 620 may include a capability message component 625, a cooperative task indication component 630, a cooperative task performance component 635, a category configuration component 640, a capability reporting configuration component 645, a cooperative service component 650, a cooperative device group component 655, an aggregated capability message component 660, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The capability message component 625 is capable of, configured to, or operable to support a means for transmitting a capability message indicative of one or more categories of one or more capabilities of the first wireless communications device to perform cooperative computing with one or more second wireless communications devices, the one or more categories of one or more sets of categories. The cooperative task indication component 630 is capable of, configured to, or operable to support a means for receiving an indication that the first wireless communications device is to perform a cooperative computational task with the one or more second wireless communications devices, the cooperative computational task in accordance with the one or more categories of capabilities of the first wireless communications device. The cooperative task performance component 635 is capable of, configured to, or operable to support a means for transmitting data, one or more inferences, or both to the one or more second wireless communications devices or to a network entity in accordance with the cooperative computational task and based on the indication.

In some examples, the one or more categories include respective ranges of capabilities, the one or more capabilities of the first wireless communications device being within the respective ranges.

In some examples, the one or more categories correspond to respective computing capabilities of the first wireless communications device.

In some examples, the respective computing capabilities include a FLOPS number capability, a memory capability, power level, or any combination thereof.

In some examples, a first category of the one or more categories corresponds to multiple capabilities of the first wireless communications device.

In some examples, the multiple capabilities include a FLOPS number capability and a memory capability.

In some examples, a first category of the one or more categories includes a joint communication and computing capability of the first wireless communications device. In some examples, a communication unit and a computing unit of the first wireless communications device share a common processing unit.

In some examples, the one or more sets of categories are included in one or more respective tables. In some examples, the capability message is indicative of the one or more categories in accordance with the capability message including one or more indexes of the one or more respective tables that correspond to the one or more categories.

In some examples, the category configuration component 640 is capable of, configured to, or operable to support a means for receiving an indication of a minimum level, a maximum level, and a step size, where a first set of categories of the one or more sets of categories includes categories that are in accordance with the minimum level, the maximum level, and the step size.

In some examples, the capability reporting configuration component 645 is capable of, configured to, or operable to support a means for receiving an indication of the one or more capabilities to be reported by the first wireless communications device, where the capability message indicative of the one or more categories of the one or more capabilities of the first wireless communications device includes the one or more categories corresponding to the indication of the one or more capabilities to be reported.

In some examples, the one or more capabilities to be reported are indicated via an indication of the one or more sets of categories corresponding to the one or more capabilities.

In some examples, the one or more capabilities are based on a cooperative service provided by the first wireless communications device and the one or more second wireless communications devices.

In some examples, the capability reporting configuration component 645 is capable of, configured to, or operable to support a means for receiving an indication of one or more quantities of bits to be used to indicate the one or more categories of the one or more capabilities of the first wireless communications device.

In some examples, the one or more categories of the one or more capabilities are indicative of a total quantity of computing resources in use by the first wireless communications device or a total quantity of available computing resources of the first wireless communications device.

In some examples, the one or more capabilities of the first wireless communications device are associated with a time range, a geographic area, or both.

In some examples, the capability message includes an aggregated capability message indicative of the one or more categories of the one or more capabilities of the first wireless communications device and the one or more second wireless communications devices.

In some examples, the aggregated capability message component 660 is capable of, configured to, or operable to support a means for receiving an indication of respective one or more categories of capabilities of the one or more second wireless communications devices, where the capability message includes the aggregated capability message based on receiving the indication of the respective one or more categories of capabilities of the one or more second wireless communications devices, and where the first wireless communications device and the one or more second wireless communications devices include a cooperative device group.

In some examples, to support receiving the indication that the first wireless communications device is to perform the cooperative computational task, the cooperative service component 650 is capable of, configured to, or operable to support a means for receiving an indication of a cooperative service provided by a cooperative device group including the first wireless communications device and the one or more second wireless communications devices, the cooperative service including the cooperative computational task and one or more other cooperative computational tasks performed by the one or more second wireless communications devices.

In some examples, the cooperative device group component 655 is capable of, configured to, or operable to support a means for transmitting, on behalf of a cooperative device group including the first wireless communications device and the one or more second wireless communications devices, an indication of a threshold quantity of devices capable of involvement in the cooperative computational task.

In some examples, to support transmitting the capability message, the capability message component 625 is capable of, configured to, or operable to support a means for transmitting the capability message periodically or based on occurrence of a triggering event.

In some examples, the capability message is further indicative of a cooperative communication capability of the first wireless communications device.

In some examples, the capability message is indicative of a hardware capability of the first wireless communications device, a software capability of the first wireless communications device, or both.

In some examples, the capability message is indicative of communication or computation parameters or service metrics associated with the cooperative computing.

In some examples, the capability message is indicative of a power supply of the first wireless communications device, a power level of the first wireless communications device, or both.

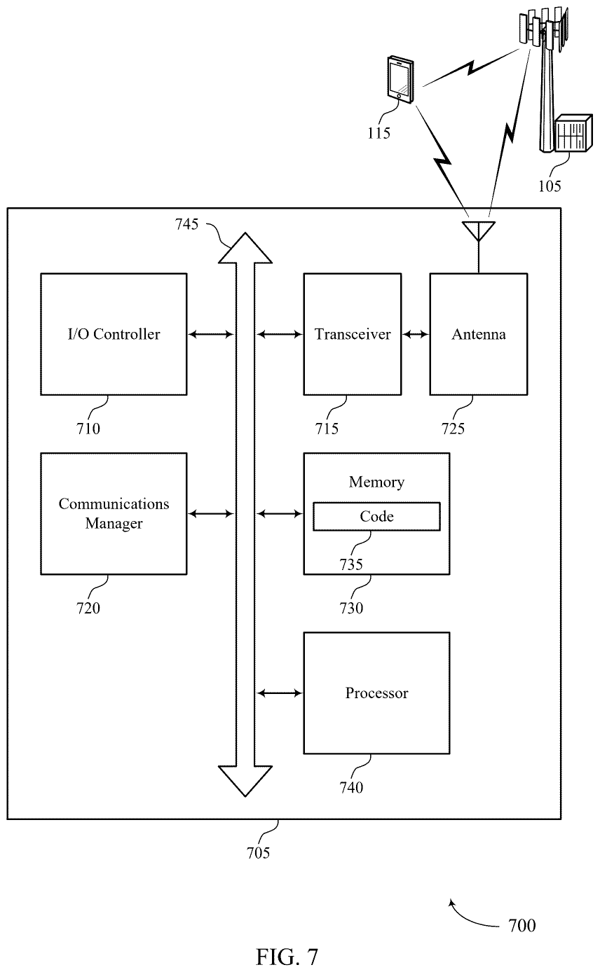

FIG. 7 shows a diagram of a system 700 including a device 705 that supports cooperative service capability information exchange in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting cooperative service capability information exchange). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for transmitting a capability message indicative of one or more categories of one or more capabilities of the first wireless communications device to perform cooperative computing with one or more second wireless communications devices, the one or more categories of one or more sets of categories. The communications manager 720 is capable of, configured to, or operable to support a means for receiving an indication that the first wireless communications device is to perform a cooperative computational task with the one or more second wireless communications devices, the cooperative computational task in accordance with the one or more categories of capabilities of the first wireless communications device. The communications manager 720 is capable of, configured to, or operable to support a means for transmitting data, one or more inferences, or both to the one or more second wireless communications devices or to a network entity in accordance with the cooperative computational task and based on the indication.

By including or configuring the communications manager 720 in accordance with examples as described herein, the device 705 may support techniques for improved communication reliability, improved user experience related to reduced processing, reduced power consumption, more efficient utilization of communication resources, improved coordination between devices, longer battery life, and improved utilization of processing capability.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of cooperative service capability information exchange as described herein, or the at least one processor 740 and the at least one memory 730 may be otherwise configured to, individually or collectively, perform or support such operations.

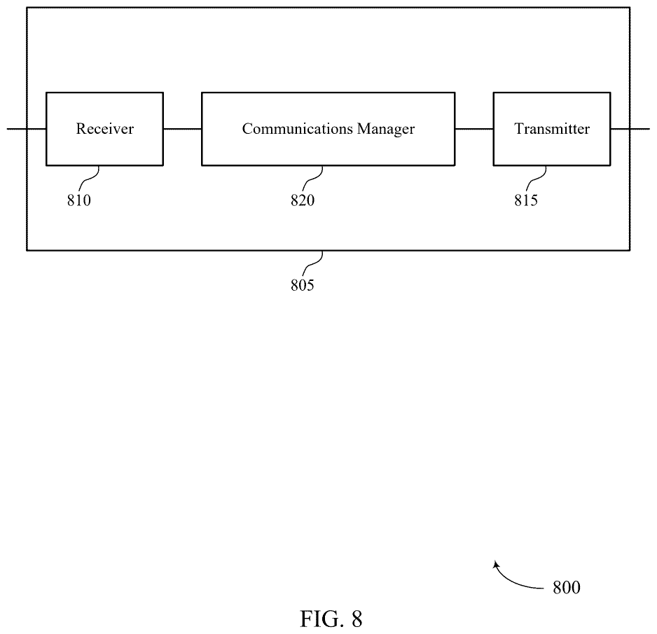

FIG. 8 shows a diagram 800 of a device 805 that supports cooperative service capability information exchange in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of cooperative service capability information exchange as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for obtaining a capability message indicative of one or more categories of one or more capabilities of a first wireless communications device to perform cooperative computing with one or more second wireless communications devices, the one or more categories of one or more sets of categories. The communications manager 820 is capable of, configured to, or operable to support a means for outputting an indication that the first wireless communications device and the one or more second wireless communications devices are to perform a cooperative computational task, the cooperative computational task in accordance with the one or more categories of the one or more capabilities of the first wireless communications device. The communications manager 820 is capable of, configured to, or operable to support a means for obtaining data, one or more inferences, or both from the first wireless communications device or the one or more second wireless communications devices in accordance with the cooperative computational task and based on the indication.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources.

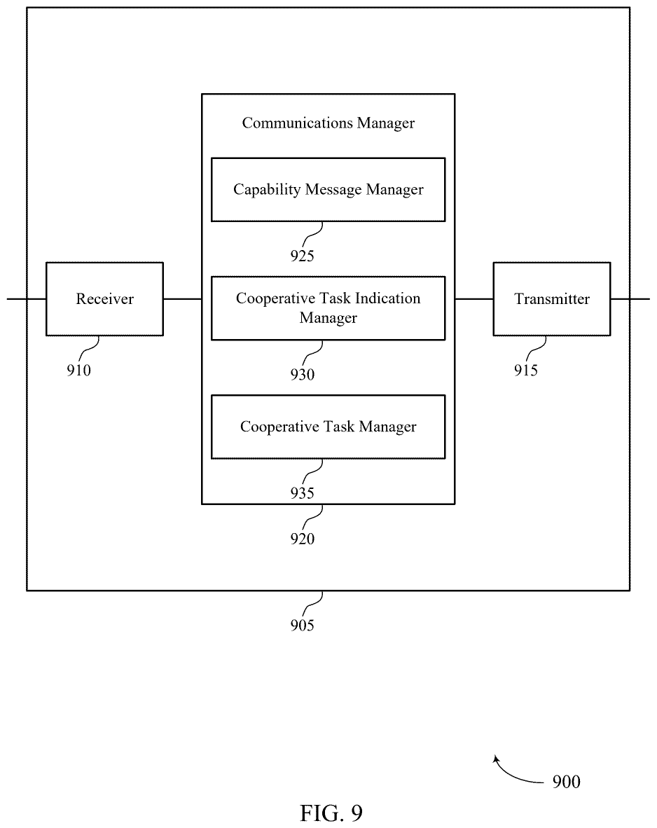

FIG. 9 shows a diagram 900 of a device 905 that supports cooperative service capability information exchange in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of cooperative service capability information exchange as described herein. For example, the communications manager 920 may include a capability message manager 925, a cooperative task indication manager 930, a cooperative task manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The capability message manager 925 is capable of, configured to, or operable to support a means for obtaining a capability message indicative of one or more categories of one or more capabilities of a first wireless communications device to perform cooperative computing with one or more second wireless communications devices, the one or more categories of one or more sets of categories. The cooperative task indication manager 930 is capable of, configured to, or operable to support a means for outputting an indication that the first wireless communications device and the one or more second wireless communications devices are to perform a cooperative computational task, the cooperative computational task in accordance with the one or more categories of the one or more capabilities of the first wireless communications device. The cooperative task manager 935 is capable of, configured to, or operable to support a means for obtaining data, one or more inferences, or both from the first wireless communications device or the one or more second wireless communications devices in accordance with the cooperative computational task and based on the indication.

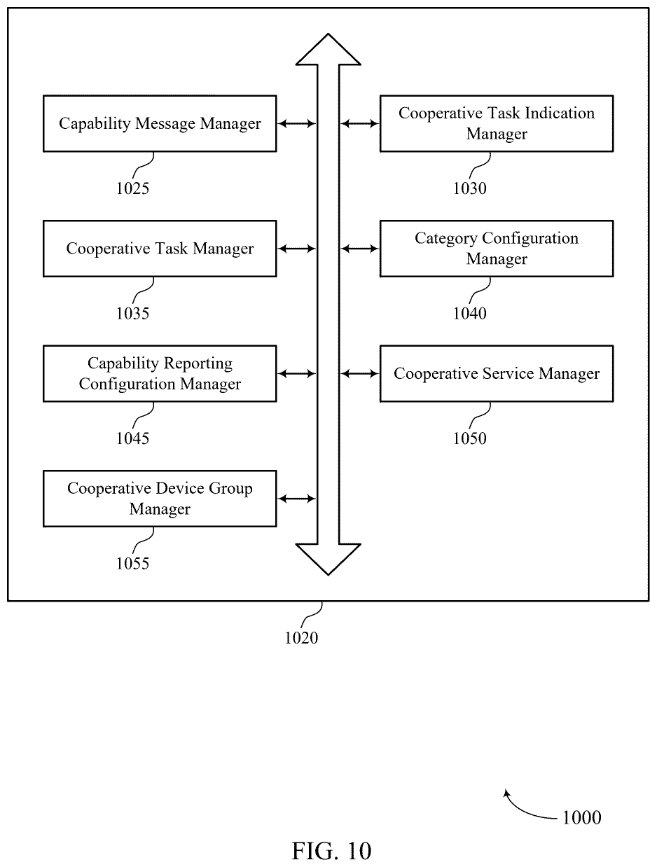

FIG. 10 shows a diagram 1000 of a communications manager 1020 that supports cooperative service capability information exchange in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of cooperative service capability information exchange as described herein. For example, the communications manager 1020 may include a capability message manager 1025, a cooperative task indication manager 1030, a cooperative task manager 1035, a category configuration manager 1040, a capability reporting configuration manager 1045, a cooperative service manager 1050, a cooperative device group manager 1055, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The capability message manager 1025 is capable of, configured to, or operable to support a means for obtaining a capability message indicative of one or more categories of one or more capabilities of a first wireless communications device to perform cooperative computing with one or more second wireless communications devices, the one or more categories of one or more sets of categories. The cooperative task indication manager 1030 is capable of, configured to, or operable to support a means for outputting an indication that the first wireless communications device and the one or more second wireless communications devices are to perform a cooperative computational task, the cooperative computational task in accordance with the one or more categories of the one or more capabilities of the first wireless communications device. The cooperative task manager 1035 is capable of, configured to, or operable to support a means for obtaining data, one or more inferences, or both from the first wireless communications device or the one or more second wireless communications devices in accordance with the cooperative computational task and based on the indication.

In some examples, the one or more categories include respective ranges of capabilities, the one or more capabilities of the first wireless communications device being within the respective ranges.

In some examples, the one or more categories correspond to respective computing capabilities of the first wireless communications device.

In some examples, the respective computing capabilities include a FLOPS number capability, a memory capability, power level, or any combination thereof.

In some examples, a first category of the one or more categories corresponds to multiple capabilities of the first wireless communications device.

In some examples, the multiple capabilities include a FLOPS number capability and a memory capability.

In some examples, a first category of the one or more categories includes a joint communication and computing capability of the first wireless communications device. In some examples, a communication unit and a computing unit of the first wireless communications device share a common processing unit.

In some examples, the one or more sets of categories are included in one or more respective tables. In some examples, the capability message is indicative of the one or more categories in accordance with the capability message including one or more indexes of the one or more respective tables that correspond to the one or more categories.

In some examples, the category configuration manager 1040 is capable of, configured to, or operable to support a means for outputting an indication of a minimum level, a maximum level, and a step size, where a first set of categories of the one or more sets of categories includes categories that are in accordance with the minimum level, the maximum level, and the step size.

In some examples, the capability reporting configuration manager 1045 is capable of, configured to, or operable to support a means for outputting an indication of the one or more capabilities to be reported by the first wireless communications device, where the capability message indicative of the one or more categories of the one or more capabilities of the first wireless communications device includes the one or more categories corresponding to the indication of the one or more capabilities to be reported.

In some examples, the one or more capabilities to be reported are indicated via an indication of the one or more sets of categories corresponding to the one or more capabilities.

In some examples, the one or more capabilities are based on a cooperative service provided by the first wireless communications device and the one or more second wireless communications devices.

In some examples, the capability reporting configuration manager 1045 is capable of, configured to, or operable to support a means for outputting an indication of one or more quantities of bits to be used to indicate the one or more categories of the one or more capabilities of the first wireless communications device.

In some examples, the one or more categories of the one or more capabilities are indicative of a total quantity of computing resources in use by the first wireless communications device or a total quantity of available computing resources of the first wireless communications device.

In some examples, the one or more capabilities of the first wireless communications device are associated with a time range, a geographic area, or both.

In some examples, the capability message includes an aggregated capability message indicative of the one or more categories of the one or more capabilities of the first wireless communications device and the one or more second wireless communications devices.

In some examples, to support outputting the indication that the first wireless communications device and the one or more second wireless communications devices are to perform the cooperative computational task, the cooperative service manager 1050 is capable of, configured to, or operable to support a means for outputting an indication of a cooperative service provided by a cooperative device group including the first wireless communications device and the one or more second wireless communications devices, the cooperative service including the cooperative computational task and one or more other cooperative computational tasks performed by the one or more second wireless communications devices.

In some examples, the cooperative device group manager 1055 is capable of, configured to, or operable to support a means for obtaining, via the first wireless communications device and on behalf of a cooperative device group including the first wireless communications device and the one or more second wireless communications devices, an indication of a threshold quantity of devices capable of involvement in the cooperative computational task.

In some examples, to support obtaining the capability message, the capability message manager 1025 is capable of, configured to, or operable to support a means for obtaining the capability message periodically or based on occurrence of a triggering event.

In some examples, the capability message is further indicative of a cooperative communication capability of the first wireless communications device.

In some examples, the capability message is indicative of a hardware capability of the first wireless communications device, a software capability of the first wireless communications device, or both.

In some examples, the capability message is indicative of communication or computation parameters or service metrics associated with the cooperative computing.

In some examples, the capability message is indicative of a power supply of the first wireless communications device, a power level of the first wireless communications device, or both.

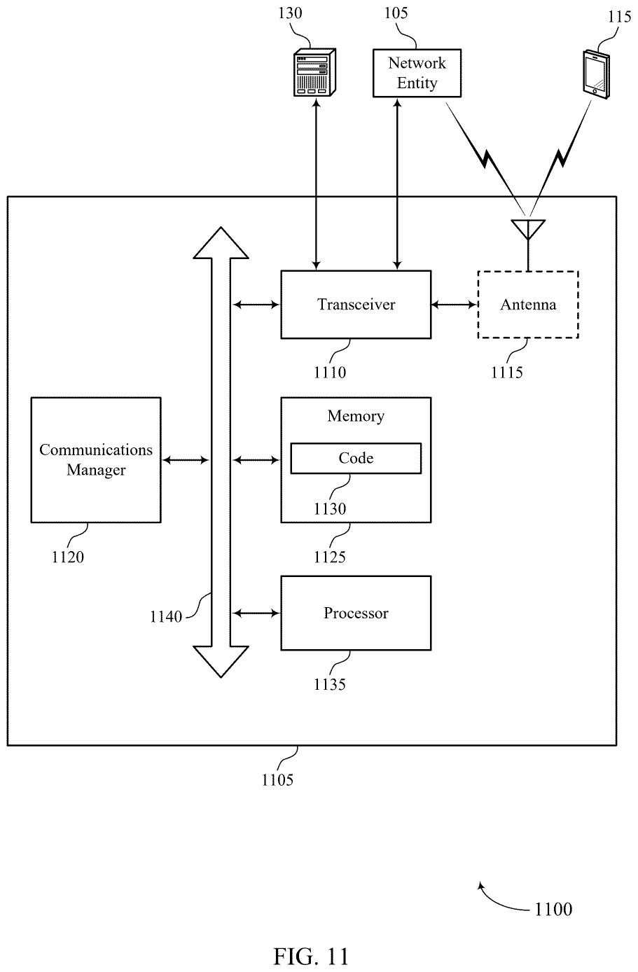

FIG. 11 shows a diagram of a system 1100 including a device 1105 that supports cooperative service capability information exchange in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting cooperative service capability information exchange). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for obtaining a capability message indicative of one or more categories of one or more capabilities of a first wireless communications device to perform cooperative computing with one or more second wireless communications devices, the one or more categories of one or more sets of categories. The communications manager 1120 is capable of, configured to, or operable to support a means for outputting an indication that the first wireless communications device and the one or more second wireless communications devices are to perform a cooperative computational task, the cooperative computational task in accordance with the one or more categories of the one or more capabilities of the first wireless communications device. The communications manager 1120 is capable of, configured to, or operable to support a means for obtaining data, one or more inferences, or both from the first wireless communications device or the one or more second wireless communications devices in accordance with the cooperative computational task and based on the indication.

By including or configuring the communications manager 1120 in accordance with examples as described herein, the device 1105 may support techniques for improved communication reliability, improved user experience related to reduced processing, reduced power consumption, more efficient utilization of communication resources, improved coordination between devices, longer battery life, and improved utilization of processing capability,

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of cooperative service capability information exchange as described herein, or the at least one processor 1135 and the at least one memory 1125 may be otherwise configured to, individually or collectively, perform or support such operations.

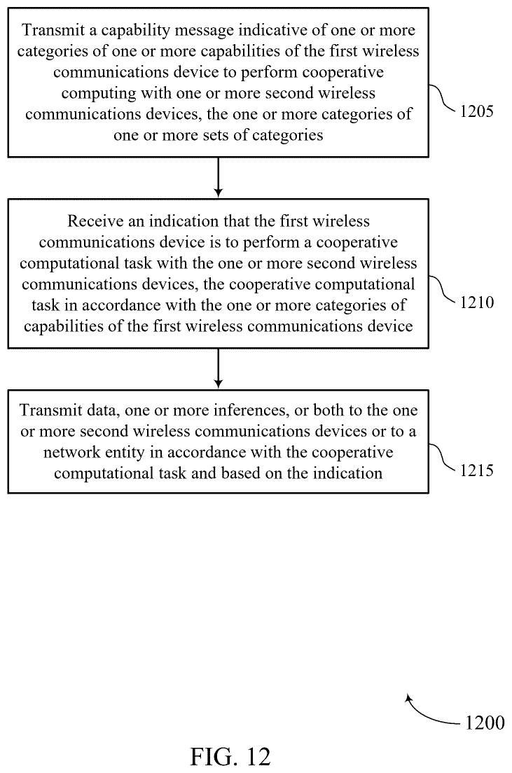

FIG. 12 shows a flowchart illustrating a method 1200 that supports cooperative service capability information exchange in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include transmitting a capability message indicative of one or more categories of one or more capabilities of the first wireless communications device to perform cooperative computing with one or more second wireless communications devices, the one or more categories of one or more sets of categories. The operations of 1205 may be performed in accordance with examples as disclosed herein. In some examples, aspects of the operations of 1205 may be performed by a capability message component 625 as described with reference to FIG. 6.

At 1210, the method may include receiving an indication that the first wireless communications device is to perform a cooperative computational task with the one or more second wireless communications devices, the cooperative computational task in accordance with the one or more categories of capabilities of the first wireless communications device. The operations of 1210 may be performed in accordance with examples as disclosed herein. In some examples, aspects of the operations of 1210 may be performed by a cooperative task indication component 630 as described with reference to FIG. 6.

At 1215, the method may include transmitting data, one or more inferences, or both to the one or more second wireless communications devices or to a network entity in accordance with the cooperative computational task and based on the indication. The operations of 1215 may be performed in accordance with examples as disclosed herein. In some examples, aspects of the operations of 1215 may be performed by a cooperative task performance component 635 as described with reference to FIG. 6.

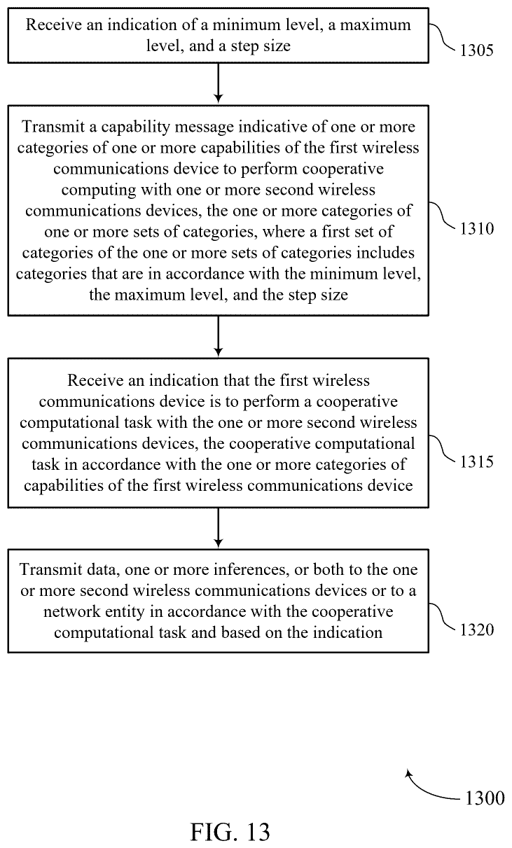

FIG. 13 shows a flowchart illustrating a method 1300 that supports cooperative service capability information exchange in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving an indication of a minimum level, a maximum level, and a step size. The operations of 1305 may be performed in accordance with examples as disclosed herein. In some examples, aspects of the operations of 1305 may be performed by a category configuration component 640 as described with reference to FIG. 6.

At 1310, the method may include transmitting a capability message indicative of one or more categories of one or more capabilities of the first wireless communications device to perform cooperative computing with one or more second wireless communications devices, the one or more categories of one or more sets of categories, where a first set of categories of the one or more sets of categories includes categories that are in accordance with the minimum level, the maximum level, and the step size. The operations of 1310 may be performed in accordance with examples as disclosed herein. In some examples, aspects of the operations of 1310 may be performed by a capability message component 625 as described with reference to FIG. 6.

At 1315, the method may include receiving an indication that the first wireless communications device is to perform a cooperative computational task with the one or more second wireless communications devices, the cooperative computational task in accordance with the one or more categories of capabilities of the first wireless communications device. The operations of 1315 may be performed in accordance with examples as disclosed herein. In some examples, aspects of the operations of 1315 may be performed by a cooperative task indication component 630 as described with reference to FIG. 6.

At 1320, the method may include transmitting data, one or more inferences, or both to the one or more second wireless communications devices or to a network entity in accordance with the cooperative computational task and based on the indication. The operations of 1320 may be performed in accordance with examples as disclosed herein. In some examples, aspects of the operations of 1320 may be performed by a cooperative task performance component 635 as described with reference to FIG. 6.

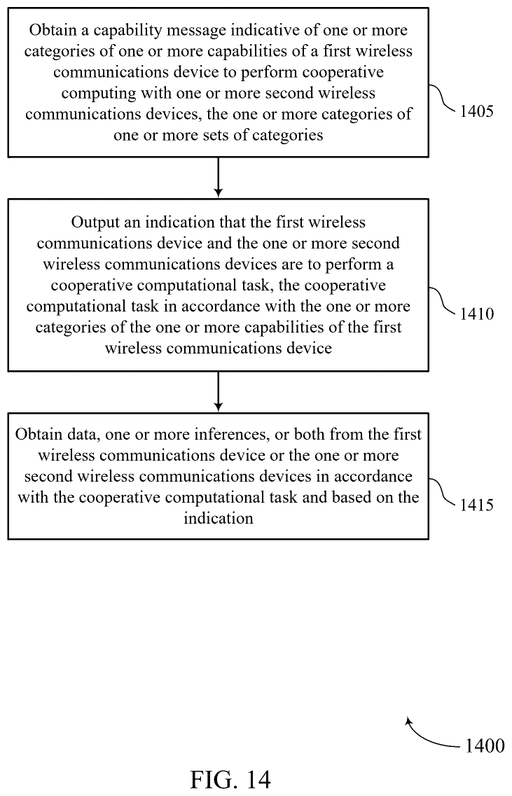

FIG. 14 shows a flowchart illustrating a method 1400 that supports cooperative service capability information exchange in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include obtaining a capability message indicative of one or more categories of one or more capabilities of a first wireless communications device to perform cooperative computing with one or more second wireless communications devices, the one or more categories of one or more sets of categories. The operations of 1405 may be performed in accordance with examples as disclosed herein. In some examples, aspects of the operations of 1405 may be performed by a capability message manager 1025 as described with reference to FIG. 10.

At 1410, the method may include outputting an indication that the first wireless communications device and the one or more second wireless communications devices are to perform a cooperative computational task, the cooperative computational task in accordance with the one or more categories of the one or more capabilities of the first wireless communications device. The operations of 1410 may be performed in accordance with examples as disclosed herein. In some examples, aspects of the operations of 1410 may be performed by a cooperative task indication manager 1030 as described with reference to FIG. 10.

At 1415, the method may include obtaining data, one or more inferences, or both from the first wireless communications device or the one or more second wireless communications devices in accordance with the cooperative computational task and based on the indication. The operations of 1415 may be performed in accordance with examples as disclosed herein. In some examples, aspects of the operations of 1415 may be performed by a cooperative task manager 1035 as described with reference to FIG. 10.

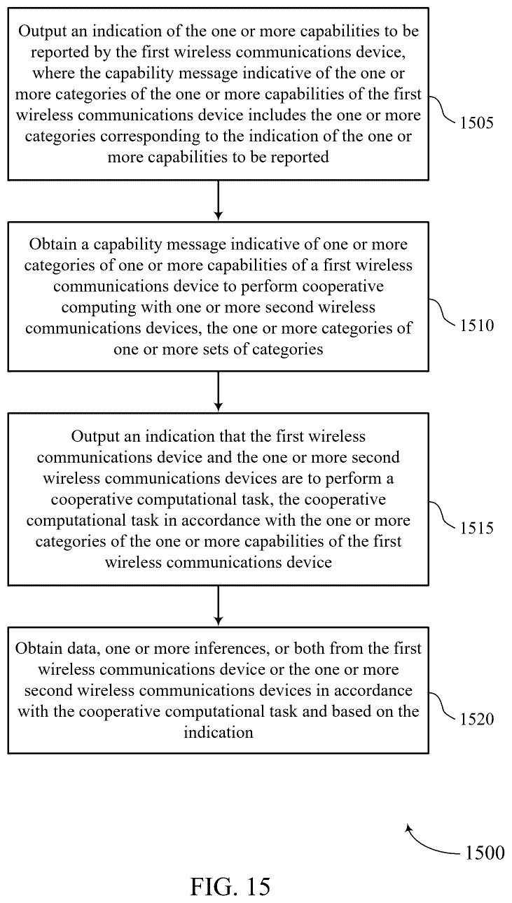

FIG. 15 shows a flowchart illustrating a method 1500 that supports cooperative service capability information exchange in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include outputting an indication of the one or more capabilities to be reported by the first wireless communications device, where the capability message indicative of the one or more categories of the one or more capabilities of the first wireless communications device includes the one or more categories corresponding to the indication of the one or more capabilities to be reported. The operations of 1505 may be performed in accordance with examples as disclosed herein. In some examples, aspects of the operations of 1505 may be performed by a capability reporting configuration manager 1045 as described with reference to FIG. 10.

At 1510, the method may include obtaining a capability message indicative of one or more categories of one or more capabilities of a first wireless communications device to perform cooperative computing with one or more second wireless communications devices, the one or more categories of one or more sets of categories. The operations of 1510 may be performed in accordance with examples as disclosed herein. In some examples, aspects of the operations of 1510 may be performed by a capability message manager 1025 as described with reference to FIG. 10.

At 1515, the method may include outputting an indication that the first wireless communications device and the one or more second wireless communications devices are to perform a cooperative computational task, the cooperative computational task in accordance with the one or more categories of the one or more capabilities of the first wireless communications device. The operations of 1515 may be performed in accordance with examples as disclosed herein. In some examples, aspects of the operations of 1515 may be performed by a cooperative task indication manager 1030 as described with reference to FIG. 10.

At 1520, the method may include obtaining data, one or more inferences, or both from the first wireless communications device or the one or more second wireless communications devices in accordance with the cooperative computational task and based on the indication. The operations of 1520 may be performed in accordance with examples as disclosed herein. In some examples, aspects of the operations of 1520 may be performed by a cooperative task manager 1035 as described with reference to FIG. 10.

The following provides an overview of aspects of the present disclosure:
Aspect 1: A method for wireless communications at a first wireless communications device, comprising: transmitting a capability message indicative of one or more categories of one or more capabilities of the first wireless communications device to perform cooperative computing with one or more second wireless communications devices, the one or more categories of one or more sets of categories; receiving an indication that the first wireless communications device is to perform a cooperative computational task with the one or more second wireless communications devices, the cooperative computational task in accordance with the one or more categories of capabilities of the first wireless communications device; and transmitting data, one or more inferences, or both to the one or more second wireless communications devices or to a network entity in accordance with the cooperative computational task and based at least in part on the indication.
Aspect 2: The method of aspect 1, wherein the one or more categories comprise respective ranges of capabilities, the one or more capabilities of the first wireless communications device being within the respective ranges.
Aspect 3: The method of any of aspects 1 through 2, wherein the one or more categories correspond to respective computing capabilities of the first wireless communications device.
Aspect 4: The method of aspect 3, wherein the respective computing capabilities comprise a FLOPS number capability, a memory capability, power level, or any combination thereof.
Aspect 5: The method of any of aspects 1 through 4, wherein a first category of the one or more categories corresponds to multiple capabilities of the first wireless communications device.
Aspect 6: The method of aspect 5, wherein the multiple capabilities comprise a FLOPS number capability and a memory capability.
Aspect 7: The method of any of aspects 1 through 6, wherein a first category of the one or more categories comprises a joint communication and computing capability of the first wireless communications device, and a communication unit and a computing unit of the first wireless communications device share a common processing unit.
Aspect 8: The method of any of aspects 1 through 7, wherein the one or more sets of categories are included in one or more respective tables, and the capability message is indicative of the one or more categories in accordance with the capability message including one or more indexes of the one or more respective tables that correspond to the one or more categories.
Aspect 9: The method of any of aspects 1 through 8, further comprising: receiving an indication of a minimum level, a maximum level, and a step size, wherein a first set of categories of the one or more sets of categories comprises categories that are in accordance with the minimum level, the maximum level, and the step size.
Aspect 10: The method of any of aspects 1 through 9, further comprising: receiving an indication of the one or more capabilities to be reported by the first wireless communications device, wherein the capability message indicative of the one or more categories of the one or more capabilities of the first wireless communications device comprises the one or more categories corresponding to the indication of the one or more capabilities to be reported.
Aspect 11: The method of aspect 10, wherein the one or more capabilities to be reported are indicated via an indication of the one or more sets of categories corresponding to the one or more capabilities.
Aspect 12: The method of any of aspects 10 through 11, wherein the one or more capabilities are based at least in part on a cooperative service provided by the first wireless communications device and the one or more second wireless communications devices.
Aspect 13: The method of any of aspects 1 through 12, further comprising: receiving an indication of one or more quantities of bits to be used to indicate the one or more categories of the one or more capabilities of the first wireless communications device.
Aspect 14: The method of any of aspects 1 through 13, wherein the one or more categories of the one or more capabilities are indicative of a total quantity of computing resources in use by the first wireless communications device or a total quantity of available computing resources of the first wireless communications device.
Aspect 15: The method of any of aspects 1 through 14, wherein the one or more capabilities of the first wireless communications device are associated with a time range, a geographic area, or both.
Aspect 16: The method of any of aspects 1 through 15, wherein the capability message comprises an aggregated capability message indicative of the one or more categories of the one or more capabilities of the first wireless communications device and the one or more second wireless communications devices.
Aspect 17: The method of aspect 16, further comprising: receiving an indication of respective one or more categories of capabilities of the one or more second wireless communications devices, wherein the capability message comprises the aggregated capability message based at least in part on receiving the indication of the respective one or more categories of capabilities of the one or more second wireless communications devices, and wherein the first wireless communications device and the one or more second wireless communications devices comprise a cooperative device group.
Aspect 18: The method of any of aspects 1 through 17, wherein receiving the indication that the first wireless communications device is to perform the cooperative computational task comprises: receiving an indication of a cooperative service provided by a cooperative device group comprising the first wireless communications device and the one or more second wireless communications devices, the cooperative service comprising the cooperative computational task and one or more other cooperative computational tasks performed by the one or more second wireless communications devices.
Aspect 19: The method of any of aspects 1 through 18, further comprising: transmitting, on behalf of a cooperative device group comprising the first wireless communications device and the one or more second wireless communications devices, an indication of a threshold quantity of devices capable of involvement in the cooperative computational task
Aspect 20: The method of any of aspects 1 through 19, wherein transmitting the capability message comprises: transmitting the capability message periodically or based at least in part on occurrence of a triggering event.
Aspect 21: The method of any of aspects 1 through 20, wherein the capability message is further indicative of a cooperative communication capability of the first wireless communications device.
Aspect 22: The method of any of aspects 1 through 21, wherein the capability message is indicative of a hardware capability of the first wireless communications device, a software capability of the first wireless communications device, or both.
Aspect 23: The method of any of aspects 1 through 22, wherein the capability message is indicative of communication or computation parameters or service metrics associated with the cooperative computing.
Aspect 24: The method of any of aspects 1 through 23, wherein the capability message is indicative of a power supply of the first wireless communications device, a power level of the first wireless communications device, or both.
Aspect 25: A method for wireless communications at a network entity, comprising: obtaining a capability message indicative of one or more categories of one or more capabilities of a first wireless communications device to perform cooperative computing with one or more second wireless communications devices, the one or more categories of one or more sets of categories; outputting an indication that the first wireless communications device and the one or more second wireless communications devices are to perform a cooperative computational task, the cooperative computational task in accordance with the one or more categories of the one or more capabilities of the first wireless communications device; and obtaining data, one or more inferences, or both from the first wireless communications device or the one or more second wireless communications devices in accordance with the cooperative computational task and based at least in part on the indication.
Aspect 26: The method of aspect 25, wherein the one or more categories comprise respective ranges of capabilities, the one or more capabilities of the first wireless communications device being within the respective ranges.
Aspect 27: The method of any of aspects 25 through 26, wherein the one or more categories correspond to respective computing capabilities of the first wireless communications device.
Aspect 28: The method of aspect 27, wherein the respective computing capabilities comprise a FLOPS number capability, a memory capability, power level, or any combination thereof.
Aspect 29: The method of any of aspects 25 through 28, wherein a first category of the one or more categories corresponds to multiple capabilities of the first wireless communications device.
Aspect 30: The method of aspect 29, wherein the multiple capabilities comprise a FLOPS number capability and a memory capability.
Aspect 31: The method of any of aspects 25 through 30, wherein a first category of the one or more categories comprises a joint communication and computing capability of the first wireless communications device, and a communication unit and a computing unit of the first wireless communications device share a common processing unit.
Aspect 32: The method of any of aspects 25 through 31, wherein the one or more sets of categories are included in one or more respective tables, and the capability message is indicative of the one or more categories in accordance with the capability message including one or more indexes of the one or more respective tables that correspond to the one or more categories.
Aspect 33: The method of any of aspects 25 through 32, further comprising: outputting an indication of a minimum level, a maximum level, and a step size, wherein a first set of categories of the one or more sets of categories comprises categories that are in accordance with the minimum level, the maximum level, and the step size.
Aspect 34: The method of any of aspects 25 through 33, further comprising: outputting an indication of the one or more capabilities to be reported by the first wireless communications device, wherein the capability message indicative of the one or more categories of the one or more capabilities of the first wireless communications device comprises the one or more categories corresponding to the indication of the one or more capabilities to be reported.
Aspect 35: The method of aspect 34, wherein the one or more capabilities to be reported are indicated via an indication of the one or more sets of categories corresponding to the one or more capabilities.
Aspect 36: The method of any of aspects 34 through 35, wherein the one or more capabilities are based at least in part on a cooperative service provided by the first wireless communications device and the one or more second wireless communications devices.
Aspect 37: The method of any of aspects 25 through 36, further comprising: outputting an indication of one or more quantities of bits to be used to indicate the one or more categories of the one or more capabilities of the first wireless communications device.
Aspect 38: The method of any of aspects 25 through 37, wherein the one or more categories of the one or more capabilities are indicative of a total quantity of computing resources in use by the first wireless communications device or a total quantity of available computing resources of the first wireless communications device.
Aspect 39: The method of any of aspects 25 through 38, wherein the one or more capabilities of the first wireless communications device are associated with a time range, a geographic area, or both.
Aspect 40: The method of any of aspects 25 through 39, wherein the capability message comprises an aggregated capability message indicative of the one or more categories of the one or more capabilities of the first wireless communications device and the one or more second wireless communications devices.
Aspect 41: The method of any of aspects 25 through 40, wherein outputting the indication that the first wireless communications device and the one or more second wireless communications devices are to perform the cooperative computational task comprises: outputting an indication of a cooperative service provided by a cooperative device group comprising the first wireless communications device and the one or more second wireless communications devices, the cooperative service comprising the cooperative computational task and one or more other cooperative computational tasks performed by the one or more second wireless communications devices.
Aspect 42: The method of any of aspects 25 through 41, further comprising: obtaining, via the first wireless communications device and on behalf of a cooperative device group comprising the first wireless communications device and the one or more second wireless communications devices, an indication of a threshold quantity of devices capable of involvement in the cooperative computational task.
Aspect 43: The method of any of aspects 25 through 42, wherein obtaining the capability message comprises: obtaining the capability message periodically or based at least in part on occurrence of a triggering event.
Aspect 44: The method of any of aspects 25 through 43, wherein the capability message is further indicative of a cooperative communication capability of the first wireless communications device.
Aspect 45: The method of any of aspects 25 through 44, wherein the capability message is indicative of a hardware capability of the first wireless communications device, a software capability of the first wireless communications device, or both.
Aspect 46: The method of any of aspects 25 through 45, wherein the capability message is indicative of communication or computation parameters or service metrics associated with the cooperative computing.
Aspect 47: The method of any of aspects 25 through 46, wherein the capability message is indicative of a power supply of the first wireless communications device, a power level of the first wireless communications device, or both.
Aspect 48: A first wireless communications device for wireless communications, comprising one or more memories storing processor-executable code, and one or more processors coupled with the one or more memories and individually or collectively operable to execute the code to cause the first wireless communications device to perform a method of any of aspects 1 through 24.
Aspect 49: A first wireless communications device for wireless communications, comprising at least one means for performing a method of any of aspects 1 through 24.
Aspect 50: A non-transitory computer-readable medium storing code for wireless communications, the code comprising instructions executable by one or more processors to perform a method of any of aspects 1 through 24.
Aspect 51: A network entity for wireless communications, comprising one or more memories storing processor-executable code, and one or more processors coupled with the one or more memories and individually or collectively operable to execute the code to cause the network entity to perform a method of any of aspects 25 through 47.
Aspect 52: A network entity for wireless communications, comprising at least one means for performing a method of any of aspects 25 through 47.
Aspect 53: A non-transitory computer-readable medium storing code for wireless communications, the code comprising instructions executable by one or more processors to perform a method of any of aspects 25 through 47.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless communications device, comprising:
one or more memories storing processor-executable code; and
one or more processors coupled with the one or more memories and individually or collectively operable to execute the code to cause the first wireless communications device to:
transmit a capability message indicative of one or more categories of one or more capabilities of the first wireless communications device to perform cooperative computing with one or more second wireless communications devices, the one or more categories of one or more sets of categories;
receive an indication that the first wireless communications device is to perform a cooperative computational task with the one or more second wireless communications devices, the cooperative computational task in accordance with the one or more categories of capabilities of the first wireless communications device; and
transmit data, one or more inferences, or both to the one or more second wireless communications devices or to a network entity in accordance with the cooperative computational task and based at least in part on the indication.

2. The first wireless communications device of claim 1, wherein:
the one or more categories comprise respective ranges of capabilities, the one or more capabilities of the first wireless communications device being within the respective ranges.

3. The first wireless communications device of claim 1, wherein:
the one or more categories correspond to respective computing capabilities of the first wireless communications device; and
the respective computing capabilities comprise a floating-point operations per second (FLOPS) number capability, a memory capability, power level, or any combination thereof.

4. The first wireless communications device of claim 1, wherein:
a first category of the one or more categories corresponds to multiple capabilities of the first wireless communications device; and
the multiple capabilities comprise a floating-point operations per second (FLOPS) number capability and a memory capability.

5. The first wireless communications device of claim 1, wherein:
the one or more sets of categories are included in one or more respective tables, and
the capability message is indicative of the one or more categories in accordance with the capability message including one or more indexes of the one or more respective tables that correspond to the one or more categories.

6. The first wireless communications device of claim 1, wherein the one or more processors are individually or collectively further operable to execute the code to cause the first wireless communications device to:
receive an indication of the one or more capabilities to be reported by the first wireless communications device, wherein the capability message indicative of the one or more categories of the one or more capabilities of the first wireless communications device comprises the one or more categories corresponding to the indication of the one or more capabilities to be reported.

7. The first wireless communications device of claim 6, wherein:
the one or more capabilities to be reported are indicated via an indication of the one or more sets of categories corresponding to the one or more capabilities; or
the one or more capabilities are based at least in part on a cooperative service provided by the first wireless communications device and the one or more second wireless communications devices.

8. The first wireless communications device of claim 1, wherein the one or more processors are individually or collectively further operable to execute the code to cause the first wireless communications device to:
receive an indication of one or more quantities of bits to be used to indicate the one or more categories of the one or more capabilities of the first wireless communications device.

9. The first wireless communications device of claim 1, wherein the one or more categories of the one or more capabilities are indicative of a total quantity of computing resources in use by the first wireless communications device or a total quantity of available computing resources of the first wireless communications device.

10. The first wireless communications device of claim 1, wherein the one or more capabilities of the first wireless communications device are associated with a time range, a geographic area, or both.

11. The first wireless communications device of claim 1, wherein:
the capability message comprises an aggregated capability message indicative of the one or more categories of the one or more capabilities of the first wireless communications device and the one or more second wireless communications devices; and
the one or more processors are individually or collectively further operable to execute the code to cause the first wireless communications device to:
receive an indication of respective one or more categories of capabilities of the one or more second wireless communications devices, wherein the capability message comprises the aggregated capability message based at least in part on receiving the indication of the respective one or more categories of capabilities of the one or more second wireless communications devices, and wherein the first wireless communications device and the one or more second wireless communications devices comprise a cooperative device group.

12. The first wireless communications device of claim 1, wherein, to receive the indication that the first wireless communications device is to perform the cooperative computational task, the one or more processors are individually or collectively operable to execute the code to cause the first wireless communications device to:
receive an indication of a cooperative service provided by a cooperative device group comprising the first wireless communications device and the one or more second wireless communications devices, the cooperative service comprising the cooperative computational task and one or more other cooperative computational tasks performed by the one or more second wireless communications devices.

13. The first wireless communications device of claim 1, wherein the one or more processors are individually or collectively further operable to execute the code to cause the first wireless communications device to:
transmit, on behalf of a cooperative device group comprising the first wireless communications device and the one or more second wireless communications devices, an indication of a threshold quantity of devices capable of involvement in the cooperative computational task.

14. The first wireless communications device of claim 1, wherein, to transmit the capability message, the one or more processors are individually or collectively operable to execute the code to cause the first wireless communications device to:
transmit the capability message periodically or based at least in part on occurrence of a triggering event.

15. The first wireless communications device of claim 1, wherein the capability message is further indicative of a cooperative communication capability of the first wireless communications device.

16. The first wireless communications device of claim 1, wherein the capability message is indicative of a hardware capability of the first wireless communications device, a software capability of the first wireless communications device, or both.

17. The first wireless communications device of claim 1, wherein the capability message is indicative of communication or computation parameters or service metrics associated with the cooperative computing.

18. The first wireless communications device of claim 1, wherein the capability message is indicative of a power supply of the first wireless communications device, a power level of the first wireless communications device, or both.

19. A network entity, comprising:
one or more memories storing processor-executable code; and
one or more processors coupled with the one or more memories and individually or collectively operable to execute the code to cause the network entity to:
obtain a capability message indicative of one or more categories of one or more capabilities of a first wireless communications device to perform cooperative computing with one or more second wireless communications devices, the one or more categories of one or more sets of categories;
output an indication that the first wireless communications device and the one or more second wireless communications devices are to perform a cooperative computational task, the cooperative computational task in accordance with the one or more categories of the one or more capabilities of the first wireless communications device; and
obtain data, one or more inferences, or both from the first wireless communications device or the one or more second wireless communications devices in accordance with the cooperative computational task and based at least in part on the indication.

20. A method for wireless communications at a first wireless communications device, comprising:
transmitting a capability message indicative of one or more categories of one or more capabilities of the first wireless communications device to perform cooperative computing with one or more second wireless communications devices, the one or more categories of one or more sets of categories;
receiving an indication that the first wireless communications device is to perform a cooperative computational task with the one or more second wireless communications devices, the cooperative computational task in accordance with the one or more categories of capabilities of the first wireless communications device; and
transmitting data, one or more inferences, or both to the one or more second wireless communications devices or to a network entity in accordance with the cooperative computational task and based at least in part on the indication.
